(19) United States
(12) Patent Application Publication
(10) Pub. No.: US 2014/0114519 A1
(43) Pub. Date: Apr. 24, 2014

(54) BATTERY, POSITIVE ELECTRODE ACTIVE MATERIAL, POSITIVE ELECTRODE, METHOD FOR MANUFACTURING POSITIVE ELECTRODE ACTIVE MATERIAL, BATTERY PACK, ELECTRONIC DEVICE, ELECTRIC VEHICLE, POWER STORAGE DEVICE, AND POWER SYSTEM

(71) Applicant: Sony Corporation, Tokyo (JP)

(72) Inventors: Masayuki Iwama, Fukushima (JP); Kaoru Abe, Fukushima (JP); Keiichi Kagami, Fukushima (JP); Tomoo Takada, Fukushima (JP); Kenichi Kawase, Fukushima (JP)

(73) Assignee: Sony Corporation, Tokyo (JP)

(21) Appl. No.: 14/053,295

(22) Filed: Oct. 14, 2013

(30) Foreign Application Priority Data
Oct. 22, 2012 (JP) 2012-232655

(51) Int. Cl. H01M 4/62; C01D 15/02; B60L 11/18; H01M 4/131

(52) U.S. Cl. CPC H01M 4/628; H01M 4/131; C01D 15/02; B60L 11/18
USPC 701/22; 429/231.1; 429/212; 423/594.15

(57) ABSTRACT

There is provided a battery including a positive electrode, a negative electrode, and an electrolyte. The positive electrode includes a positive electrode active material layer, on at least one surface of a positive electrode current collector, including a binder and a positive electrode active material of a deoxidized lithium transition metal composite oxide. The positive electrode active material layer shows first and second peaks of oxygen amounts generated from a type of the positive electrode active material in the positive electrode active material layer when the positive electrode active material layer is heated in a charge state of higher than or equal to 4.2 V and lower than or equal to 4.5 V in a lithium antipode potential, the second peak appearing in a temperature region higher than a temperature region of the first peak. At least the second peak appears in a temperature region higher than 220° C.

### CROSS REFERENCES TO RELATED APPLICATIONS

The present application claims priority to Japanese Priority Patent Application JP 2012-232655 filed in the Japan Patent Office on Oct. 22, 2012, the entire content of which is hereby incorporated by reference.

### BACKGROUND

The present disclosure relates to a battery, a positive electrode active material, a positive electrode, and a method for manufacturing the positive electrode active material. The present disclosure further relates to a battery pack, an electronic device, an electric vehicle, a power storage device, and a power system each using the battery.

In recent years, mobile information electronic devices such as mobile phones, video cameras, and laptop personal computers have been common, and these devices have had higher functions and have become downsized and lighter. Power sources for these devices are non-reusable primary batteries or repeatedly reusable secondary batteries. Among them, nonaqueous electrolyte batteries, in particular, lithium ion secondary batteries, have been more and more demanded because of comprehensively excellent balance in terms of high functionality, downsizing, weight reduction, economic efficiency, and the like. These devices are having higher functions and are being more downsized, and nonaqueous electrolyte batteries such as lithium ion secondary batteries are expected to have a higher energy density.

These lithium ion secondary batteries have had disadvantages such as gas generation due to internal short circuit during charging, heat generation due to heating from the outside of the battery, and oxygen release due to a thermal decomposition reaction on a surface of a positive electrode in a charge state, caused by the heat generation of the battery. The reaction of oxygen generated from the positive electrode with an electrolyte near the positive electrode causes a burning reaction in the inside of the battery to proceed and generates heat, and results in a decrease in the safety of the battery. Further, in a case of using silicon (Si), a metal such as tin (Sn), or a metal alloy as a negative electrode active material, oxygen released from the positive electrode reacts directly with the negative electrode active material in a chain reaction manner, which causes an abnormal situation such as ignition of the battery.

In order to suppress the burning reaction in the inside of the battery, as shown in JP 2010-199006A for example, an approach to decrease the reactivity at the time of short circuit has been proposed, by covering surfaces of positive electrode active material particles with a material having low reactivity with the electrolyte, such as a metal oxide, a metal, or a hydroxyl group.

Further, as shown in JP 2009-135084A, JP 2009-146811A, or JP 2011-187190A for example, an approach to have an oxygen absorbing compound absorb oxygen generated at the time of a battery reaction has been described, by mixing the oxygen absorbing compound having an oxygen-absorbing function together with a positive electrode active material in a positive electrode active material layer. For example, as an oxygen absorbing material, SiO₂₋ₓMgO_{1-y}, Al₂O_{3-z} and the like (JP 2009-135084A), LiMoO₂ (JP 2009-146811A), and V₂O_{5-α}, MnO_{2-β}, MoO_{2-y}, and the like (JP 2011-187190A) are contained in the positive electrode in JP 2009-135084A, JP 2009-146811A, and JP 2011-187190A.

In JP H11-144734A, an approach is described to use a positive electrode containing a composite material of an oxygen absorbing material and a conductive material together with a positive electrode active material. As the oxygen absorbing material, oxides having oxygen deficiency such as CuO, FeO, ZnO, and TiO are disclosed.

### SUMMARY

However, by the approach in JP 2010-199006A, the provision of a covering layer over the positive electrode active material is not sufficient to reduce the amount of oxygen generated by the thermal decomposition reaction of the positive electrode active material. Further, the approaches in JP 2009-135084A, JP 2009-146811A, JP 2011-187190A, and JP H11-144734A do not reduce the amount of oxygen itself generated by the thermal decomposition reaction of the positive electrode active material, and the oxygen absorbing function of the oxygen absorbing material is not sufficiently high.

According to an embodiment of the present disclosure, there is provided a battery which can suppress oxygen generation from a positive electrode at the time when the battery temperature is increased by short circuit or the like, a positive electrode active material, and a method for manufacturing the positive electrode and the positive electrode active material. Further, according to another embodiment of the present disclosure, there is provided a battery pack, an electronic device, an electric vehicle, a power storage device, and a power system each using such a battery.

According to an embodiment of the present disclosure, there is provided a battery including a positive electrode, a negative electrode, and an electrolyte. The positive electrode includes a positive electrode active material layer on at least one surface of a positive electrode current collector, the positive electrode active material layer including a binder and a positive electrode active material of a deoxidized lithium transition metal composite oxide. The positive electrode active material layer shows a first peak and a second peak of oxygen amounts generated from a type of the positive electrode active material in the positive electrode active material layer when the positive electrode active material layer is heated in a charge state of higher than or equal to 4.2 V and lower than or equal to 4.5 V in a lithium antipode potential, the second peak appearing in a temperature region higher than a temperature region of the first peak. At least the second peak appears in a temperature region higher than 220° C.

According to another embodiment of the present disclosure, there is provided a battery including a positive electrode, a negative electrode, and an electrolyte. The positive electrode includes a positive electrode active material layer on at least one surface of a positive electrode current collector, the positive electrode active material layer including a binder and a positive electrode active material of a deoxidized lithium transition metal composite oxide. The deoxidized lithium transition metal composite oxide is at least one of a deoxidized lithium transition metal composite oxide having a layered rock salt structure in which a peak intensity ratio I₀₀₃/I₁₀₄, which is a ratio of diffracted peak intensity I₀₀₃ of a peak attributed to a (003) plane to diffracted peak intensity I₁₀₄ of a peak attributed to a (104) plane, is higher than or equal to 0.65 and lower than or equal to 0.80, and a deoxidized lithium transition metal composite oxide having a spinel structure in which a peak intensity ratio I₃₁₁/I₁₁₁, which is a ratio of diffracted peak intensity I₃₁₁ of a peak attributed to a (311) plane to diffracted peak intensity I₁₁₁ of a peak attributed to a (111) plane, is higher than or equal to 0.30 and lower than or equal to 0.40, the diffracted peak intensity being measured in an X-ray diffraction measurement using a CuKα-ray for an X-ray source.

According to another embodiment of the present disclosure, there is provided a positive electrode active material including at least one of a deoxidized lithium transition metal composite oxide having a layered rock salt structure in which a peak intensity ratio I₀₀₃/I₁₀₄, which is a ratio of diffracted peak intensity I₀₀₃ of a peak attributed to a (003) plane to diffracted peak intensity I₁₀₄ of a peak attributed to a (104) plane, is higher than or equal to 0.65 and lower than or equal to 0.80, and a deoxidized lithium transition metal composite oxide having a spinel structure in which a peak intensity ratio I₃₁₁/I₁₁₁, which is a ratio of diffracted peak intensity I₃₁₁ of a peak attributed to a (311) plane to diffracted peak intensity I₁₁₁ of a peak attributed to a (111) plane, is higher than or equal to 0.30 and lower than or equal to 0.40, the diffracted peak intensity being measured in an X-ray diffraction measurement using α CuKα-ray for an X-ray source.

According to another embodiment of the present disclosure, there is provided a positive electrode including a positive electrode active material layer on at least one surface of a positive electrode current collector, the positive electrode active material layer including a binder and a positive electrode active material of a deoxidized lithium transition metal composite oxide. The deoxidized lithium transition metal composite oxide is at least one of a deoxidized lithium transition metal composite oxide having a layered rock salt structure in which a peak intensity ratio I₀₀₃/I₁₀₄, which is a ratio of diffracted peak intensity I₀₀₃ of a peak attributed to a (003) plane to diffracted peak intensity I₁₀₄ of a peak attributed to a (104) plane, is higher than or equal to 0.65 and lower than or equal to 0.80, and a deoxidized lithium transition metal composite oxide having a spinel structure in which a peak intensity ratio I₃₁₁/I₁₁₁, which is a ratio of diffracted peak intensity I₃₁₁ of a peak attributed to a (311) plane to diffracted peak intensity I₁₁₁ of a peak attributed to a (111) plane, is higher than or equal to 0.30 and lower than or equal to 0.40, the diffracted peak intensity being measured in an X-ray diffraction measurement using a CuKα-ray for an X-ray source.

According to another embodiment of the present disclosure, there is provided a method for manufacturing a positive electrode active material, the method including mixing a lithium transition metal composite oxide and a reducing agent, and baking the reducing agent and the lithium transition metal composite oxide under a non-oxygen atmosphere at a temperature higher than or equal to a temperature at which the reducing agent starts reducing.

Note that the positive electrode may include, at least as a part of the conductive material, the reducing agent or an oxide of the reducing agent. The reducing agent or the oxide of the reducing agent may be included in combination with or separately from the deoxidized lithium transition metal composite oxide in the positive electrode active material layer.

Further, a battery pack, an electronic device, an electric vehicle, a power storage device, and a power system each according to an embodiment of the present disclosure include the above-described battery.

In the present disclosure, since the positive electrode active material subjected to deoxidizing treatment in advance is used, the oxygen generation amount itself from the positive electrode can be reduced. That is, in the present disclosure, it is unnecessary to provide the covering layer over the positive electrode active material in order to reduce the generated oxygen or to mix the oxygen absorbing material in order not to react the generated oxygen with the electrolyte. Further, it is possible to reduce the oxygen generation amount in the battery more than in those cases.

According to an embodiment of the present disclosure, it is possible to suppress the reaction between oxygen and the electrolyte and a process of a burning reaction due to the above reaction in the inside of the battery. Accordingly, it is possible to suppress heat generation of the battery and a decrease in battery characteristics. Furthermore, it is possible to obtain a battery pack, an electronic device, an electric vehicle, a power storage device, and a power system each including a battery whose heat generation and decrease in battery characteristics are suppressed.

Additional features and advantages are described herein, and will be apparent from the following Detailed Description and the figures.

### BRIEF DESCRIPTION OF THE FIGURES

FIG. 1 is a cross-sectional view showing one structural example of a cylindrical battery according to a second embodiment of the present disclosure;

FIG. 2 is a cross-sectional view showing one structural example of an electrode laminating structure of the cylindrical battery according to the second embodiment of the present disclosure;

FIG. 3 is an exploded perspective view showing one structural example of a thin battery according to a third embodiment of the present disclosure;

FIG. 4 is a cross-sectional view showing the structural example of the thin battery according to the third embodiment of the present disclosure;

FIGS. 5A to 5C are each views and an exploded perspective view showing another structural example of the thin battery according to the third embodiment of the present disclosure;

FIG. 6 is a cross-sectional view showing one structural example of a coin battery according to a fourth embodiment of the present disclosure;

FIG. 7 is a block diagram showing a circuit configuration example of a battery pack according to a fifth embodiment of the present disclosure;

FIG. 8 is a schematic view showing an example of a home power storage system according to a sixth embodiment of the present disclosure;

FIG. 9 is a schematic view showing an example of a structure of a hybrid vehicle employing a series hybrid system according to the sixth embodiment of the present disclosure;

FIGS. 10A and 10B are graphs showing results of peak intensity measurements obtained by performing X-ray diffraction measurements on positive electrode active materials of samples 1-1 and 1-7, using a CuKαray for an X-ray source;

FIG. 11 is a graph showing oxygen generation amounts in positive electrodes of samples 1-1, 5-4, and 1-7 in a 4.2 V charge state, measured with use of a gas chromatography/mass spectrometer provided with a pyrolyzer in a sample insertion point;

FIG. 12 is a graph showing heat generation amounts of a positive electrode with respect to temperature in the positive electrode in the 4.2 V charge state of samples 1-1, 5-4, and 1-7, measured by a differential scanning calorimetry; and

FIG. 13 is a graph of the peak intensity measurement results obtained by performing X-ray diffraction measurements on positive electrode active materials of samples 6-1 and 6-2, using a CuKαray for an X-ray source.

### DETAILED DESCRIPTION

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted. Note that the description will be made in the following order.

1. First embodiment (examples of positive electrode active material and positive electrode according to embodiment of the present disclosure)

2. Second embodiment (example of cylindrical battery in which positive electrode according to embodiment of the present disclosure is used)

3. Third embodiment (example of thin battery in which positive electrode according to embodiment of the present disclosure is used)

4. Fourth embodiment (example of coin battery in which positive electrode according to embodiment of the present disclosure is used)

5. Fifth embodiment (example of battery pack in which battery according to embodiment of the present disclosure is used)

6. Sixth embodiment (example of power storage system in which battery according to embodiment of the present disclosure is used)

### 1. First Embodiment

A first embodiment will show a positive electrode active material, a method for manufacturing the positive electrode active material, and a positive electrode using the positive electrode active material each according to an embodiment of the present disclosure.

(1-1) Structure of Positive Electrode Active Material

The positive electrode active material according to the embodiment of the present disclosure is a deoxidized lithium transition metal composite oxide obtained by mixing a reducing agent with a lithium transition metal composite oxide capable of intercalating and deintercalating lithium, and extracting oxygen from the lithium transition metal composite oxide by baking. This treatment is hereinafter referred to as deoxidizing treatment as appropriate. This deoxidized lithium transition metal composite oxide is obtained through a reduction.

[Lithium Transition Metal Composite Oxide]

Examples of the lithium transition metal composite oxide, which is a precursor of a positive electrode active material before the deoxidizing treatment, include materials represented by (Chem. I), (Chem. II), and (Chem. III) each having a layered rock salt structure. The lithium transition metal composite oxide preferably contains, for example, at least one selected from the group consisting of cobalt (Co), nickel (Ni), manganese (Mn), aluminum (Al), magnesium (Mg), and titanium (Ti). Examples of such a lithium transition metal composite oxide include LiNi_{0.50}CO_{0.20}Mn_{0.03}O₂, LiₐCO₂ (a≈1), Li_{b}NiO₂ (b≈1), Li_{c1}Ni_{c2}Co_{1-c2}O₂ (c1≈1, 0<c2<1), and the like.

Among the examples, the lithium transition metal composite oxide represented by (Chem. II), which mainly contains nickel (Ni) as a transition metal, i.e., in which the ratio of nickel in the transition metal is 50 mol % or higher, is preferably used. Nickel can be used as a substitute material for cobalt, which is expensive. Further, with use of the lithium transition metal composite oxide mainly containing nickel as the transition metal, a high discharge capacity can be obtained. On the other hand, the lithium transition metal composite oxide mainly containing nickel generates a large amount of gas when being used as a positive electrode active material. Accordingly, with use of the positive electrode active material obtained by performing the deoxidizing treatment according to an embodiment of the present disclosure on the lithium transition metal composite oxide mainly containing nickel, it is possible to obtain a high discharge capacity and oxygen generation suppressing effects and to suppress a decrease in battery characteristics.

With a positive electrode material having a layered rock salt structure, oxygen is generated when the temperature becomes about 200° C. to 220° C. or higher. For example, when the temperature in the inside of a battery is raised by short circuit or the like, the battery temperature might also be raised to the above-described temperature. Therefore, oxygen might be generated at the time of short circuit or the like, and a further burning reaction might proceed in the inside of the battery. Accordingly, the deoxidizing treatment in advance has significant oxygen generation suppressing effects.

Further, as the lithium transition metal composite oxide, it is possible to use a positive electrode material represented by (Chem. IV) having a spinel structure. One of examples of such a lithium transition metal composite oxide is Li_{d}Mn₂O₄ (d≈1).

The temperature of a positive electrode material having a spinel structure at which oxygen is generated is about 450° C. to 650° C., which is higher than that of the positive electrode material having the layered rock salt structure. That is, oxygen is less likely to be generated with the positive electrode material having the spinel structure compared to the positive electrode material having the layered rock salt structure. However, the positive electrode material having the spinel structure is a material with which oxygen is generated when the battery temperature becomes higher; accordingly, constant oxygen generation suppressing effects can be obtained by performing the deoxidizing treatment in advance.

LiₑNi_{(1-f-g)}Mn_{f}M1_{g}O₍₂₋ₕ₎Xᵢ (Chem. I)

(in the formula, M1 represents at least one of elements selected from 2 to 15 group elements except for nickel (Ni) and manganese (Mn); X represents at least one of 16 and 17 group elements except for oxygen (O); e, f, g, h, and i are values in ranges of 0≦e≦1.5, 0≦f≦1.0, 0≦g≦1.0, −0.10≦h≦0.20, and 0≦i≦0.2. Note that the composition of lithium differs depending on the state of charge/discharge, and the value of e represents a value in a complete discharge state).

LiⱼNi₍₁₋ₖ₎M2ₖO₍₂₋₁₎Fₘ (Chem. II)

(in the formula, M2 represents at least one selected from the group consisting of cobalt (Co), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); j, k, l, and m are values in ranges of 0.8≦j≦1.2, 0.005≦k≦0.5, −0.1≦l≦0.2, and 0≦m≦0.1. Note that the composition of lithium differs depending on the state of charge/discharge, and the value of j represents a value in a complete discharge state).

LiₙCo₍₁₋ₒ₎M3ₒO₍₂₋ₚ₎F_{q} (Chem. III)

(in the formula, M3 represents at least one selected from the group consisting of nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); n, o, p, and q are values in ranges of 0.8≦n≦1.2, 0≦o<0.5, −0.1≦p≦0.2, and 0≦q≦0.1. Note that the composition of lithium differs depending on the state of charge/discharge, and the value of n represents a value in a complete discharge state).

LiᵣMn₍₂₋ₛ₎M4ₛOₜFᵤ (Chem. IV)

(in the formula, M4 represents at least one selected from the group consisting of cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); r, s, t, and u are values in ranges of 0.9≦r≦1.1, 0≦s≦0.6, 3.7≦t≦4.1, and 0≦u≦0.1. Note that the composition of lithium differs depending on the state of charge/discharge, and the value of r represents a value in a complete discharge state).

Note that the composition of oxygen shown in the above (Chem. I) to (Chem. IV) is that before the deoxidizing treatment. For example, the composition of oxygen tends to be lower after the deoxidizing treatment than before the deoxidizing treatment. Therefore, after the deoxidizing treatment, the range of the composition of oxygen in (Chem. I) to (Chem. IV) becomes a smaller range of values than before the deoxidizing treatment.

For example, after the deoxidizing treatment, oxygen tends to be decreased by about 1% on a mass basis from oxygen before the deoxidizing treatment. For example, in LiNi_{0.7}Co_{0.19}Al_{0.01}O₂ (molecular weight: 96.1), which can be represented by (Chem. I), the mass percentage of oxygen before the deoxidizing treatment is 32/96.1=33%, and the mass percentage of oxygen after the deoxidizing treatment becomes 33%−1%=32%. By using this, the composition of oxygen after the deoxidizing treatment is calculated as follows: LiNi_{0.7}Co_{0.19}Al_{0.01}O₂ before the deoxidizing treatment changes to LiNi_{0.7}Co_{0.19}Al_{0.01}O_{1.94} after the deoxidizing treatment. That is, the molar ratio of oxygen after the deoxidizing treatment is decreased by 0.06 from that before the deoxidizing treatment. Therefore, in (Chem. I), −0.10≦h≦0.20 (O_{1.8 to 2.1}) before the deoxidizing treatment tends to be −0.04≦h≦0.26 (O_{1.74 to 2.04)} after the deoxidizing treatment.

The above-described lithium transition metal composite oxide preferably has a stronger crystal structure of the lithium transition metal composite oxide itself in order to suppress distortion of the crystal structure due to extraction of oxygen. For example, the lithium transition metal composite oxide is preferably formed using a plurality of transition metal elements by substituting, for nickel (Ni), which is a transition metal in lithium nickelate (LiNiO₂) having a layered rock salt structure, a dissimilar metal element such as cobalt (Co), aluminum (Al), magnesium (Mg), titanium (Ti), or manganese (Mn). As for lithium manganate (LiMn₂O₄) or the like having a spinel structure, similarly, a dissimilar metal element is preferably substituted for manganese (Mn), which is a transition metal. Accordingly, the crystal structure is unlikely to be distorted by extraction of oxygen in the deoxidizing treatment, and it is possible to obtain a positive electrode active material which has a small oxygen generation amount and in which a decrease in functions as a positive electrode active material is suppressed.

Furthermore, from a viewpoint of obtaining a higher electrode filling performance and higher cycling characteristics, composite particles may be used which are obtained by covering surfaces of coarse particles formed using any of the above-described lithium transition metal composite oxides with particulates formed using any other lithium transition metal composite oxide, a carbon material, or the like.

Other examples of the positive electrode material capable of intercalating and deintercalating lithium include a metal oxide containing a metal other than lithium. Examples of such an oxide include vanadium oxide (V₂O₅), titanium dioxide (TiO₂), manganese dioxide (MnO₂), and the like. The positive electrode material may be a metal oxide other than the above-described positive electrode material. Further, two types or more of the above lithium transition metal composite oxides and the metal oxide that does not contain lithium may be mixed in a given combination.

[Reducing Agent]

As the reducing agent, it is possible to use a material that is vaporized by being bound to oxygen, or a material which forms the positive electrode by being bound to oxygen, the material having a function as an electrode material such as a positive electrode active material, a conductive material, or a binder. Such materials are preferably able to be used as an electrode material or to be removed easily when remaining by non-reacting in the deoxidizing treatment. Specifically, it is possible to use a carbon material, a metal material, an organic material, an inorganic material, or the like, for example.

Examples of the carbon material include carbon black, graphite, and the like. Since the temperature at which the carbon material starts reducing is as low as about 400° C., it is possible to set the baking temperature at the time of baking in the deoxidizing treatment to be relatively low, and accordingly, it is possible to extract oxygen from the lithium transition metal composite oxide without distorting the crystal structure of the lithium transition metal composite oxide. Therefore, the carbon material is preferable in that respect.

Examples of the metal material include a metal with high reducibility, such as copper (Cu), nickel (Ni), or molybdenum (Mo). For example, the temperatures at which copper, nickel, and molybdenum start reducing are about 200° C., about 300° C., and about 700° C., respectively. The metal material is preferable in that a metal functioning as the reducing agent becomes a material that is unlikely to adversely affect other battery characteristics although the metal remains as an oxide.

Examples of the organic material include an organic compound having reducibility at the time of baking, such as a saccharide like a monosaccharide, a disaccharide, a trisaccharide, or a multisaccharide, a fatty acid like a saturated fatty acid or an unsaturated fatty acid, or a resin like polyethylene or polyvinyl alcohol. Since a reduction occurs at a relatively low temperature, the organic material is preferable in that the process is easy.

Examples of the inorganic material include phosphorous acid, phosphite, hypophosphorous acid, hypophosphite, lithium aluminum hydride, sodium borohydride, tin chloride, oxalic acid, formic acid, hydrogen, and the like. The inorganic material is preferable in that a strong reduction power can be obtained depending on the combination of materials.

When the positive electrode active material subjected to the deoxidizing treatment according to an embodiment of the present disclosure is a lithium transition metal composite oxide having a layered rock salt structure, a peak intensity ratio I₀₀₃/I₁₀₄, which is a ratio of diffracted peak intensity I₀₀₃ of a peak attributed to a (003) plane to diffracted peak intensity I₁₀₄ of a peak attributed to a (104) plane, is preferably higher than or equal to 0.65 and lower than or equal to 0.80, more preferably higher than or equal to 0.68 and lower than or equal to 0.75, the peaks being measured in an X-ray diffraction (XRD) measurement using a CuKα-ray for an X-ray source.

When the positive electrode active material subjected to the deoxidizing treatment according to an embodiment of the present disclosure is a lithium transition metal composite oxide having a spinel crystal structure, a peak intensity ratio I₃₁₁/I₁₁₁, which is a ratio of diffracted peak intensity I₃₁₁ of a peak attributed to a (311) plane to diffracted peak intensity T₁₁₁ of a peak attributed to a (111) plane, is preferably higher than or equal to 0.30 and lower than or equal to 0.40, the peaks being measured in an X-ray diffraction (XRD) measurement using a CuKα-ray for an X-ray source.

Note that when the positive electrode active material is the lithium transition metal composite oxide having the layered rock salt structure, the diffracted peak intensity I₀₀₃ of the peak attributed to the (003) plane appears at a position where the diffracted angle (2θ) is 17° to 20°, and the diffracted peak intensity I₁₀₄ of the peak attributed to the (104) plane appears at a position where the diffracted angle (2θ) is 43° to 47°.

Note that when the positive electrode active material is the lithium transition metal composite oxide having the spinel crystal structure, the diffracted peak intensity I₃₁₁ of the peak attributed to the (311) plane appears at a position where the diffracted angle (2θ) is 34° to 40°, and the diffracted peak intensity I₁₁₁ of the peak attributed to the (111) plane appears at a position where the diffracted angle (2θ) is 16° to 22°.

In a case where the peak intensity ratio I₀₀₃/I₁₀₄ is lower than the above-described range, too many oxygen ions are extracted from the positive electrode active material, and accordingly, the crystal structure of the positive electrode active material is distorted and initial charge/discharge efficiency is decreased. Further, in a case where peak intensity ratio I₀₀₃/I₁₀₄ is higher than the above-described range, the deoxidizing treatment does not properly proceed, and extraction of oxygen ions from the positive electrode active material is little and the safety is decreased.

In a case where the peak intensity ratio I₃₁₁/I₁₁₁ is lower than the above-described range, too many oxygen ions are extracted from the positive electrode active material, and accordingly, the crystal structure of the positive electrode active material is distorted and initial charge/discharge efficiency is decreased. Further, in a case where peak intensity ratio I₃₁₁/I₁₁₁ is higher than the above-described range, the deoxidizing treatment does not properly proceed, and extraction of oxygen ions from the positive electrode active material is little and the safety is decreased.

The specific surface of the positive electrode active material is preferably greater than or equal to 0.05 m²/g and less than or equal to 2.0 m²/g, more preferably greater than or equal to 0.2 m²/g and less than or equal to 0.7 m²/g in a measurement by a Brunauer, Emmett, Teller (BET) method using nitrogen (N₂) as an absorbing gas, because more effective charge/discharge characteristics can be obtained in the above ranges.

(1-2) Structure of Positive Electrode

In a positive electrode 21, a positive electrode active material layer 21B containing a positive electrode active material is formed on at least a surface of a positive electrode current collector 21A. As the positive electrode current collector 21A, for example, metal foil such as aluminum (Al) foil, nickel (Ni) foil, or stainless steel (SUS) foil can be used.

The positive electrode active material layer 21B contains, for example, the positive electrode active material, a conductive material, and a binder. As the positive electrode active material, the above-described positive electrode active material subjected to the deoxidizing treatment is mainly contained.

As the conductive material, a carbon material such as carbon black or graphite is used for example. In a case where the reducing agent used at the time of the deoxidizing treatment is a carbon material, a carbonized material by baking, or the like and has a property that enhances conductivity, at least any one of the non-reacted material or a burned product of the reducing agent which remains from the reducing agent used at the time of the deoxidizing treatment may be used as the conductive material.

As the binder, for example, at least one selected from a resin material such as polyvinylidene difluoride (PVdF), polytetrafluoroethylene (PTFE), polyacrylonitrile (PAN), styrene-butadiene rubber (SBR), and carboxymethylcellulose (CMC), a copolymer having such a resin material as a main component, and the like is used.

According to an embodiment of the present disclosure, with the positive electrode 21 containing the positive electrode active material having the predetermined peak intensity ratio obtained by the X-ray diffraction measurement, when the positive electrode 21 is heated in a charge state such that a lithium antipode potential is higher than or equal to 4.2 V and lower than or equal to 4.5 V, there are two or more peaks of oxygen amounts generated from a type of the positive electrode active material in the positive electrode active material layer 21B, with respect to the temperature. That is, there are a first peak and a second peak that appears in a temperature region higher than a temperature region of the first peak, and at least the second peak appears in a temperature region higher than 220° C.

The second peak more preferably appears in a region higher than 250° C. After oxygen is generated at a temperature at which the first peak appears, oxygen is generated again at a temperature at which the second peak appears. That is why, when the second peak appears on a higher temperature side, the entire oxygen generation amount can be reduced and accordingly an increase in battery temperature can be suppressed.

Here, in a case of a lithium transition metal composite oxide which is not subjected to the deoxidizing treatment, only the first peak appears and the second peak does not appear, and oxygen tends to be generated at once when the temperature is increased to a predetermined temperature. Further, the first peak of the positive electrode active material subjected to the deoxidizing treatment according to an embodiment of the present disclosure is notably lower than the first peak of the lithium transition metal composite oxide which is not subjected to the deoxidizing treatment. This shows that the oxygen generation amount from the positive electrode active material subjected to the deoxidizing treatment according to an embodiment of the present disclosure is notably reduced. On the other hand, the positive electrode active material subjected to the deoxidizing treatment according to an embodiment of the present disclosure shows the second peak in a temperature region higher than a temperature region of the first peak. This is considered to be because the positive electrode active material has a portion where oxygen ions are unlikely to be extracted and oxygen ions that are not extracted by the deoxidizing treatment are generated as oxygen in a temperature region higher than the temperature at which the first peak appears.

Further, the second peak is preferably higher than the first peak, i.e., the oxygen generation amount at the second peak is preferably larger than the oxygen generation amount at the first peak. This is because oxygen generation can be suppressed at the time when the battery temperature is increased and a battery temperature increase due to the oxygen generation can be suppressed. The more oxygen ions are extracted from the lithium transition metal composite oxide, the less the oxygen generation amount at the first peak becomes and the more the oxygen generation amount at the second peak becomes. Therefore, in a case where the extracted amount of oxygen ions is small, the first peak becomes higher than the second peak, and as the extracted amount of oxygen ions is larger, the second peak becomes higher than the first peak. Further, as more oxygen ions are extracted from the lithium transition metal composite oxide, the temperature at which the second peak appears shifts to the higher temperature side. Accordingly, the higher the second peak of the oxygen generation amount than the first peak, the smaller the oxygen generation amount near the first peak on a low temperature side becomes. Further, as the second peak shifts to the higher temperature side, the battery temperature is unlikely to be increased to the temperature at which the second peak appears and oxygen is unlikely to be generated near the second peak.

However, in a case where the second peak becomes too high, although the increase in battery temperature due to oxygen generation can be suppressed, the initial efficiency of the battery might be decreased. Therefore, it is preferable to adjust the degree of the extraction of oxygen ions considering a desired battery performance.

Note that the oxygen generation amount is represented by an integrated value (area) of a graph of the oxygen generation amount with respect to the temperature. An integrated range is a range in which the intensity of oxygen generation with respect to a baseline of an oxygen component is 3% or higher of the peak intensity.

Note that in the present disclosure, the oxygen amounts generated from a type of the positive electrode active material in the positive electrode in the charge state, with respect to the temperature, is measured by pyrolysis-gas chromatography/mass spectrometry. Specifically, the oxygen amounts generated from a type of the positive electrode active material in the positive electrode, with respect to the temperature, is obtained by analyzing the positive electrode in the charge state by a gas chromatography/mass spectrometer provided with a pyrolyzer in a sample insertion point (Py-GC/MS). In a case of using a carbon material as the reducing agent for example, the oxygen generation amount can be obtained by measuring the amount of deoxidized carbon (CO₂) generated by reaction of the extracted oxygen from the positive electrode active material and the carbon material and by calculating the oxygen amount from the amount of deoxidized carbon.

Here, one type of the positive electrode active material refers to positive electrode active materials having the same crystal structure. That is, even in a case where the same type of transition metal elements are contained, crystal structures differ when the content ratio of each transition metal element differs, and accordingly, the positive electrode active material is regarded as different positive electrode active materials. For example, LiNi_{1/3}Co_{1/3}Mn_{1/3}O₂ and LiNi_{0.5}Co_{0.2}Mn_{0.3}O₂ are different positive electrode active materials, and each of LiNi_{1/3}Co_{1/3}Mn_{1/3}O₂ and LiNi_{0.5}CO_{0.2}Mn_{0.3}O₂ is regarded as one type of the positive electrode active material.

When the first and second peaks of the oxygen amounts generated from a type of the positive electrode active material in the positive electrode in the charge state, with respect to the temperature, satisfy the above-described conditions, even when two or more types of materials are mixed as the positive electrode active material, the positive electrode 21 according to an embodiment of the present disclosure can be obtained. When two or more types of materials are mixed, in the positive electrode active material, as the lithium transition metal composite oxide before the deoxidizing treatment, and when at least one thereof mainly contains nickel (Ni), the first peak becomes notably high owing to the material mainly containing nickel (Ni). Therefore, when a positive electrode active material obtained by performing the deoxidizing treatment according to an embodiment of the present disclosure on a lithium transition metal composite oxide mainly containing nickel is contained in a positive electrode as one of the mixed two or more types of the positive electrode active material, higher oxygen generation suppressing effects can be obtained.

In the positive electrode 21, a non-reacted reducing agent in the deoxidizing treatment or an oxide of the reducing agent may remain.

Note that even when content ratios of each element in the positive electrode active materials are the same in a positive electrode using, as the positive electrode active material, the lithium transition metal composite oxide that is synthesized to have a small content of oxygen in advance and the positive electrode 21 using, as the positive electrode active material, the synthesized lithium transition metal composite oxide subjected to the deoxidizing treatment according to an embodiment of the present disclosure so that the content of oxygen is small, the first and second peaks are considered to appear differently. Therefore, it is preferably determined whether the positive electrode active material according to an embodiment of the present disclosure is used not only by physical properties of the positive electrode active material but also by the oxygen amounts generated from a type of the positive electrode active material in the positive electrode, with respect to the temperature, measured by the above-described pyrolysis-gas chromatography/mass spectrometry.

The positive electrode 21 includes a positive electrode lead 25 connected to an end portion of the positive electrode current collector 21A by spot welding or ultrasonic welding. The positive electrode lead 25 is preferably formed of net-like metal foil, but there is no problem when a non-metal material is used as long as an electrochemically and chemically stable material is used and an electric connection is obtained. Examples of materials of the positive electrode lead 25 include aluminum (Al), nickel (Ni), and the like.

(1-3) Manufacturing Method of Positive Electrode Active Material and Positive Electrode

The positive electrode active material according to an embodiment of the present disclosure is manufactured by the following method.

[Positive Electrode Active Material]

A lithium transition metal oxide and a reducing agent are sufficiently mixed and the mixture is baked under a non-oxygen atmosphere (reducing atmosphere) at a temperature higher than or equal to the temperature at which the reducing agent starts reducing. Time for baking is adjusted as appropriate depending on the baking temperature and a desired degree of the extraction of oxygen ions.

For example, since the temperature at which a carbon material starts reducing is about 400° C., in a case of using the carbon material as the reducing agent, the baking is performed at 400° C. or higher. Further, in a case where the baking temperature is too high, a crystal structure might be distorted by too much extraction of oxygen ions from the lithium transition metal oxide. The distortion of the crystal structure causes a decrease in the initial charge/discharge efficiency of a battery. Therefore, in a case of using the carbon material as the reducing agent, it is preferable to perform the baking at a temperature lower than or equal to 600° C., at which gas generation due to extraction of oxygen ions is ceased.

In a case where the reducing agent is the above-described metal material, the reduction starting temperature is about 200° C. to 900° C., and in a case where the reducing agent is the above-described organic material or inorganic material, the reduction starting temperature is about 150° C. to 650° C. In both cases, the reduction starting temperature has a wider temperature range than that of the carbon material. In these cases, it is preferable to perform the baking at 1100° C. or lower in order not to cause the distortion of the crystal structure.

Note that, for example, in a case of using the carbon material as the reducing agent and performing the baking at a temperature over 600° C., the crystal structure of the positive electrode active material might be distorted for example. This is because the reduction by the reducing agent is caused by the extraction of oxygen ions. Therefore, in a case of using a material having a higher reduction starting temperature as the reducing agent, an example of which being copper powder having a reduction starting temperature of 800° C., the deoxidizing treatment is not started even at over 600° C. and the crystal structure is not distorted. That is, the baking temperature at the time of the deoxidizing treatment depends on the reducing agent, and the property of the positive electrode active material is not determined only by the baking temperature at the time of the deoxidizing treatment.

The amount of the reducing agent to be mixed at the time of the deoxidizing treatment is preferably more than or equal to 0.1 parts and less than or equal to 20 parts with respect to 95 parts of the lithium transition metal composite oxide. Further, in a case of placing much value on the suppression of the increase in battery temperature, the amount of the reducing agent to be mixed at the time of the deoxidizing treatment is more preferably more than or equal to 5 parts and less than or equal to 20 parts with respect to 95 parts of the lithium transition metal composite oxide; in a case of placing much value on the maintenance of the initial efficiency, the amount of the reducing agent to be mixed at the time of the deoxidizing treatment is more preferably more than or equal to 0.1 parts and less than or equal to 5 parts with respect to 95 parts of the lithium transition metal composite oxide.

This is because, since a more amount of the reducing agent to be mixed results in a more amount of oxygen ions to be extracted, the second peak of the oxygen generation amount is higher than the first peak of the oxygen generation amount, the oxygen generation amount as a whole can be reduced, and the increase in battery temperature can be suppressed. On the other hand, since a more amount of the reducing agent to be mixed results in a more amount of oxygen ions to be extracted, the crystal structure is easily distorted and the initial efficiency tends to be decreased.

Note that, in the related art, a positive electrode active material is manufactured through a baking step under a reducing atmosphere in the manufacture of a positive electrode active material. In a case of using such a positive electrode active material, only a notably high first peak of the oxygen amount generated from a type of the positive electrode active material in the positive electrode in a charge state, with respect to the temperature, is generated, and a second peak thereof is not generated. On the other hand, as in the present disclosure, in a case of manufacturing the positive electrode active material by mixing with the reducing agent and through a baking step under a reducing atmosphere, the first peak on the low temperature side is low and the second peak on the high temperature side is higher than the first peak, so that when the positive electrode active material is used as a battery material, the oxygen generation amount can be reduced.

[Manufacturing Method of Positive Electrode]

A positive electrode mixture is prepared by mixing the positive electrode active material subjected to the deoxidizing treatment, a conductive material, and a binder, and a paste-form positive electrode mixture slurry is prepared by dispersing the positive electrode mixture into a solvent such as N-methyl-2-pyrrolidinone. Next, the positive electrode mixture slurry is applied on the positive electrode current collector 21A with a doctor blade, a bar coater, or the like, the solvent is dried, and the dried mixture is compression molded with a rolling press machine or the like, so that the positive electrode active material layer 21B is formed and the positive electrode 21 is manufactured.

In this case, at least any one of a non-reacted remaining reducing agent at the time of the deoxidizing treatment of the lithium transition metal composite oxide and an oxide of the reducing agent may remain in the positive electrode mixture. In a case where such a residue of the reducing agent has conductivity, the residue may be used as a part of or all of the conductive material. That is, in a case where the amount of the residue of the reducing agent is sufficient as the conductive material, the residue mixed with the positive electrode active material after the deoxidizing treatment may be used as the conductive material, and a conductive material is not necessarily further added at the time of preparing the positive electrode mixture slurry.

### 2. Second Embodiment

A second embodiment will show a cylindrical battery using a positive electrode containing a positive electrode active material subjected to the deoxidizing treatment according to the first embodiment.

(2-1) Structure of Cylindrical Battery

[Structure of Cylindrical Battery]

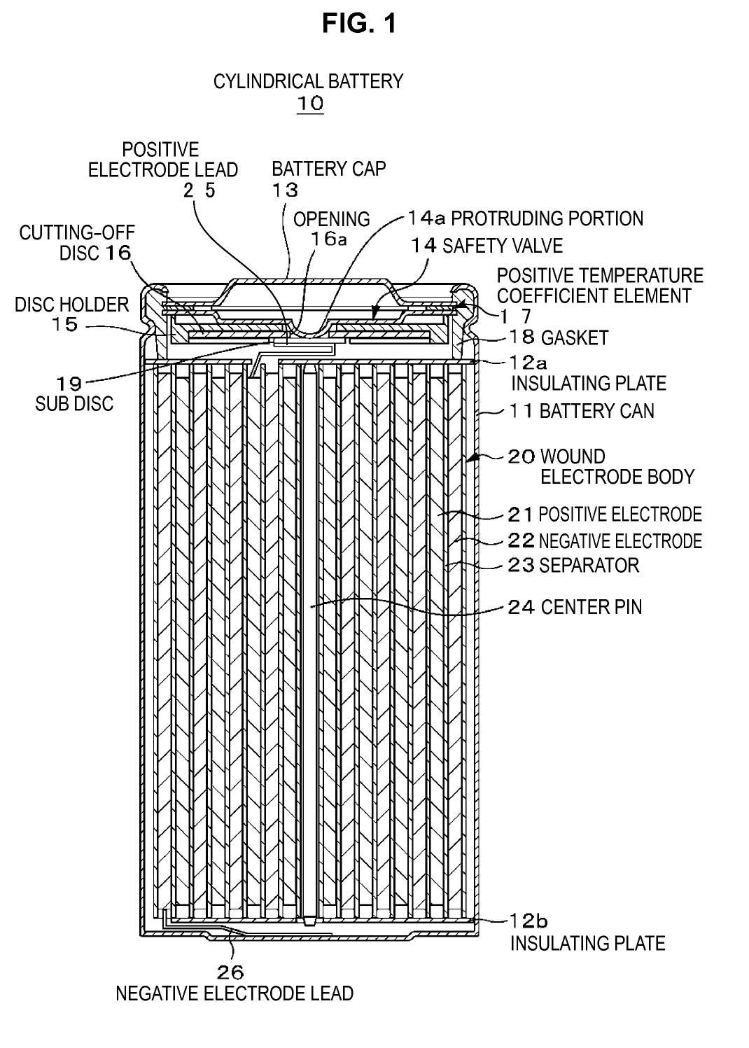

FIG. 1 is a cross-sectional view showing an example of a structure of a cylindrical battery 10 according to the second embodiment. The cylindrical battery 10 is, for example, a lithium ion secondary battery capable of charging and discharging. This cylindrical battery 10 includes an unshown liquid electrolyte (hereinafter referred to as electrolyte solution as appropriate) and a wound electrode body 20 formed by winding the belt-like positive electrode 21 and negative electrode 22 with a separator 23 according to an embodiment of the present disclosure interposed therebetween, in the inside of a substantially hollow columnar battery can 11.

The battery can 11 is formed using iron plated with nickel for example, and one end portion of the battery can 11 is closed and the other end portion thereof is open. In the inside of the battery can 11, a pair of insulating plates 12a and 12b are disposed to be perpendicular to a surface where the electrode body is wound such that the wound electrode body 20 is interposed between the insulating plates 12a and 12b.

Examples of materials for the battery can 11 include iron (Fe), nickel (Ni), stainless steel (SUS), aluminum (Al), titanium (Ti), and the like. In order to prevent corrosion by an electrochemical electrolyte solution due to charge/discharge of the cylindrical battery 10, the battery can 11 may be plated with nickel for example. The open end portion of the battery can 11 is provided with a battery cap 13 which is a positive electrode lead plate, and a safety valve mechanism and a positive temperature coefficient (PTC) element 17 provided in the inside of the battery cap 13, by caulking via a gasket 18 for insulating sealing.

The battery cap 13 is formed using the same material as the battery can 11, for example, and includes an opening for exhausting a gas generated in the inside the battery. In the safety valve mechanism, a safety valve 14, a disc holder 15, and a cutting-off disc 16 are sequentially laminated. A protruding portion 14a of the safety valve 14 is connected to the positive electrode lead 25 led from the wound electrode body 20, with a sub disc 19 interposed between the protruding portion 14a and the positive electrode lead 25, the sub disc 19 being disposed to cover an opening 16a provided in a center portion of the cutting-off disc 16. By connecting the safety valve 14 and the positive electrode lead 25 with the sub disc 19 interposed therebetween, the positive electrode lead 25 is prevented from being drawn into the opening 16a when the safety valve 14 is reversed. Further, the safety valve mechanism is electrically connected to the battery cap 13 via the positive temperature coefficient element 17.

When the internal pressure of the cylindrical battery 10 is a certain value or higher by short circuit in the inside of the battery, heating from the outside of the battery, or the like, the safety valve 14 is reversed, so that the safety valve mechanism cuts electrical connection between the protruding portion 14a (i.e., the battery can 13) and the wound electrode body 20. That is, when the safety valve 14 is reversed, the cutting-off disc 16 puts pressure to the positive electrode lead 25 so that the safety valve 14 becomes disconnected to the positive electrode lead 25. The disc holder 15 is formed using an insulating material, and when the safety valve 14 is reversed, the safety valve 14 becomes isolated from the cutting-off disc 16.

Further, when a more amount of gas is generated in the inside of the battery and the internal pressure of the battery is further increased, a part of the safety valve 14 can be broken up so that the gas can be exhausted to the battery cap 13 side.

Furthermore, for example, a plurality of degassing openings (not shown) are provided in the periphery of the opening 16a of the cutting-off disc 16 so that the gas can be exhausted effectively to the battery cap 13 side when the gas is generated from the wound electrode body 20.

When the temperature is increased, the resistivity of the positive temperature coefficient element 17 is increased and the positive temperature coefficient element 17 cuts off current by cutting the electrical connection between the battery cap 13 and the wound electrode body 20, so that abnormal heat generation due to overcurrent is prevented. The gasket 18 is formed using an insulating material for example, and asphalt is applied on a surface of the gasket 18.

The wound electrode body 20 housed in the cylindrical battery 10 is wound around a center pin 24. The wound electrode body 20 is formed by sequentially laminating the positive electrode 21 and the negative electrode 22 with the separator 23 interposed therebetween, and by winding the laminate in the longitudinal direction. The positive electrode lead 25 is connected to the positive electrode 21, and a negative electrode lead 26 is connected to the negative electrode 22. The positive electrode lead 25 is, as described above, electrically connected to the battery cap 13 by welding to the safety valve 14, and the negative electrode lead 26 is electrically connected to the battery can 11 by welding.

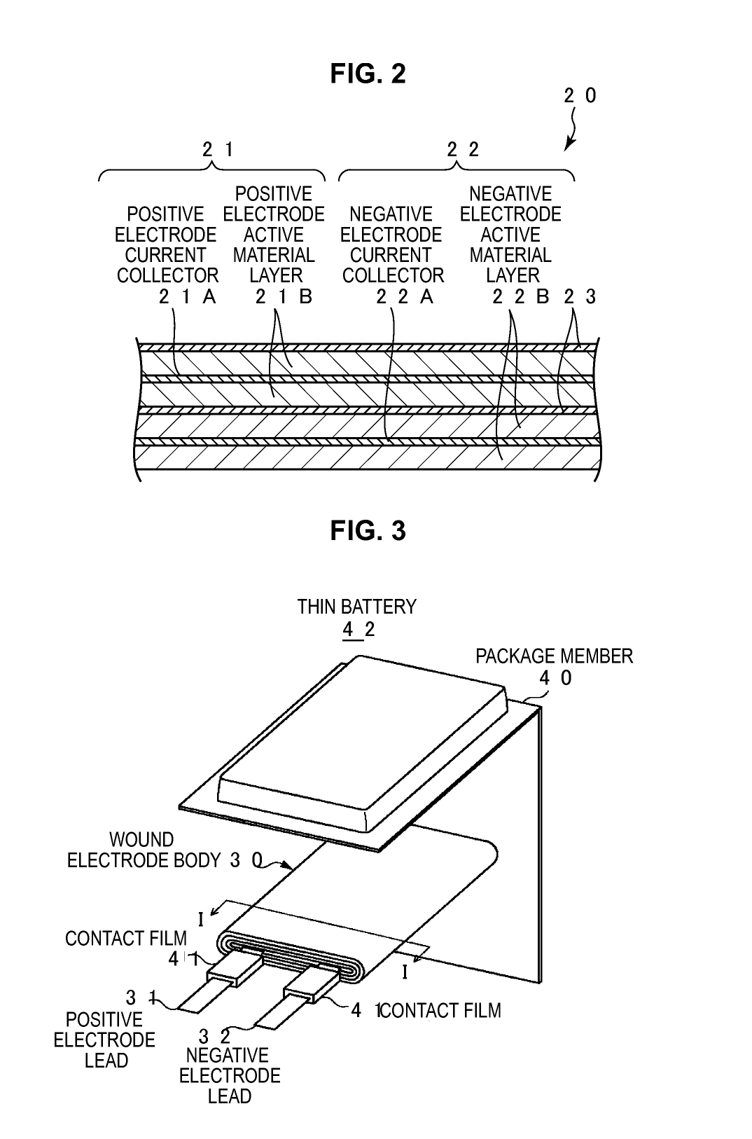

FIG. 2 is an enlarged view of a part of the wound electrode body 20 shown in FIG. 1. The positive electrode 21, the negative electrode 22, and the separator 23 will be described below in detail.

[Positive Electrode]

The positive electrode 21 is obtained by forming, on at least a surface of the positive electrode current collector 21A, the positive electrode active material layer 21B containing the positive electrode active material subjected to the deoxidizing treatment, and the positive electrode 21 described in the first embodiment can be used.

[Negative Electrode]

The negative electrode 22 has a structure in which a negative electrode active material layer 22B is provided on at least a surface of a negative electrode current collector 22A, and is disposed such that the negative electrode active material layer 22B is opposed to the positive electrode active material layer 21B.

The negative electrode active material layer 22B contains, as a negative electrode active material, one or more types of negative electrode materials capable of intercalating and deintercalating lithium, and the negative electrode active material according to an embodiment of the present disclosure mainly contains natural graphite.

The negative electrode active material layer 22B contains, for example, the negative electrode active material, a binder, and a conductive material as necessary. As the binder, at least one selected from resin materials such as polyvinylidene difluoride (PVdF), polytetrafluoroethylene (PTFE), polyacrylonitrile (PAN), styrene-butadiene rubber (SBR), and carboxymethylcellulose (CMC), a copolymer containing such a resin material as a main component, and the like is used. As the conductive material, for example, a carbon material such as carbon black or filamentous carbon is used.

Examples of a negative electrode material capable of intercalating and deintercalating lithium and capable of being used together with natural graphite as the negative electrode active material include carbon materials such as non-graphitizable carbon, graphitizable carbon, pyrocarbons, cokes, glassy carbons, an organic polymeric material burned substance, carbon fiber, and activated carbon. Among these, the cokes include pitch coke, needle coke, petroleum coke, and the like. The organic polymeric material burned substance refers to a carbonized material obtained by baking a polymer material such as a phenol resin or a furan resin at an appropriate temperature, and some of such carbonized materials are classified into non-graphitizable carbon or graphitizable carbon. It is preferable to use such a carbon material because the crystal structure is very unlikely to be changed at the time of charge/discharge, a high charge/discharge capacity can be obtained, and excellent cycling characteristics can be obtained. Further, non-graphitizable carbon is preferable because excellent cycling characteristics can be obtained. Furthermore, it is preferable to use a carbon material having a low charge/discharge potential, i.e., a charge/discharge potential that is close to that of a lithium metal, because the battery can obtain a higher energy density easily.

Examples of the negative electrode material capable of intercalating and deintercalating lithium and capable of being used together with natural graphite further include a material capable of intercalating and deintercalating lithium and containing at least one kind of metal elements and semi-metal elements as a constituent element. This is because a high energy density can be obtained with use of such a material. Such a material is preferably used together with natural graphite because the high energy density and also excellent cycling characteristics can be obtained. The negative electrode active material may be a simple substance, an alloy, or a compound of the metal element or the semi-metal element, or may contain, at least partly, a phase of one or more of the simple substance, alloy, or compound of the metal element or the semi-metal element. Note that in the present disclosure, the alloy includes a material formed with two or more kinds of metal elements and a material containing one or more kinds of metal elements and one or more kinds of semi-metal elements. Further, the alloy may contain a non-metal element. Examples of its texture include a solid solution, a eutectic (eutectic mixture), an intermetallic compound, and one in which two or more kinds thereof coexist.

Examples of the metal element or semi-metal element contained in this negative electrode material include a metal element or a semi-metal element capable of forming an alloy together with lithium. Specifically, such examples include magnesium (Mg), boron (B), aluminum (Al), titanium (Ti), gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd), and platinum (Pt). These materials may be crystalline or amorphous.

It is preferable to use, as the negative electrode active material, for example, a material containing, as a constituent element, a metal element or a semi-metal element of 4B group in the short periodical table. It is more preferable to use a material containing at least one of silicon (Si) and tin (Sn) as a constituent element. It is even more preferable to use a material containing at least silicon. This is because silicon (Si) and tin (Sn) each have a high capability of intercalating and deintercalating lithium, so that a high energy density can be obtained. Examples of the negative electrode material containing at least one of silicon and tin include a simple substance, an alloy, or a compound of silicon, a simple substance, an alloy, or a compound of tin, and a material containing, at least partly, a phase of one or more kinds thereof.

Examples of the alloy of silicon include alloys containing, as a second constituent element other than silicon, at least one selected from the group consisting of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr). Examples of the alloy of tin include alloys containing, as a second constituent element other than tin (Sn), at least one selected from the group consisting of silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr).

Examples of the compound of tin (Sn) or the compound of silicon (Si) include compounds containing oxygen (O) or carbon (C), which may contain any of the above-described second constituent elements in addition to tin (Sn) or silicon (Si).

Among them, as the negative electrode material, an SnCoC-containing material is preferable which contains cobalt (Co), tin (Sn), and carbon (C) as constituent elements, the content of carbon is higher than or equal to 9.9 mass % and lower than or equal to 29.7 mass %, and the ratio of cobalt in the total of tin (Sn) and cobalt (Co) is higher than or equal to 30 mass % and lower than or equal to 70 mass %. This is because the high energy density and excellent cycling characteristics can be obtained in these composition ranges.

The SnCoC-containing material may also contain another constituent element as necessary. For example, it is preferable to contain, as the other constituent element, silicon (Si), iron (Fe), nickel (Ni), chromium (Cr), indium (In), niobium (Nb), germanium (Ge), titanium (Ti), molybdenum (Mo), aluminum (Al), phosphorous (P), gallium (Ga), or bismuth (Bi), and two or more kinds of these elements may be contained. This is because the capacity characteristics or cycling characteristics can be further increased.

Note that the SnCoC-containing material has a phase containing tin (Sn), cobalt (Co), and carbon (C), and this phase preferably has a low crystalline structure or an amorphous structure. Further, in the SnCoC-containing material, at least a part of carbon (C), which is a constituent element, is preferably bound to a metal element or a semi-metal element that is another constituent element. This is because, when carbon (C) is bound to another element, aggregation or crystallization of tin (Sn) or the like, which is considered to cause a decrease in cycling characteristics, can be suppressed.

Examples of a measurement method for examining the binding state of elements include X-ray photoelectron spectroscopy (XPS). In the XPS, so far as natural graphite is concerned, a peak of the 1s orbit (C1s) of carbon appears at 284.5 eV in an energy-calibrated apparatus such that a peak of the 4f orbit (Au4f) of a gold (Au) atom is obtained at 84.0 eV. Also, so far as surface contamination carbon is concerned, a peak of the 1s orbit (C1s) of carbon appears at 284.8 eV. On the contrary, when a charge density of the carbon element is high, for example, when carbon is bound to a metal element or a semi-metal element, the peak of C1s appears in a region lower than 284.5 eV. That is, when a peak of a combined wave of C1s obtained regarding the SnCoC-containing material appears in a region lower than 284.5 eV, at least a part of carbon contained in the SnCoC-containing material is bound to a metal element or a semi-metal element, which is another constituent element.

In the XPS measurement, for example, the peak of C1s is used for correcting the energy axis of a spectrum. In general, since surface contamination carbon exists on the surface, the peak of C1s of the surface contamination carbon is fixed at 284.8 eV, and this peak is used as an energy reference. In the XPS measurement, since a waveform of the peak of C1s is obtained as a form including the peak of the surface contamination carbon and the peak of carbon in the SnCoC-containing material, the peak of the surface contamination carbon and the peak of the carbon in the SnCoC-containing material are separated from each other by means of analysis using, for example, a commercially available software program. In the analysis of the waveform, the position of a main peak existing on the lowest binding energy side is used as an energy reference (284.8 eV).

Further, examples of the negative electrode material capable of intercalating and deintercalating lithium include other metal materials and polymer compounds. Examples of the other metal compounds include oxides such as lithium titanate (Li₄Ti₅O₁₂), manganese dioxide (MnO₂), and vanadium oxide (V₂O₅, V₆O₁₃), sulfides such as nickel sulfide (NiS) and molybdenum sulfide (MoS₂), and nitrides of lithium such as lithium nitride (Li₃N); and examples of the polymer materials include polyacetylene, polyaniline, polypyrrole, and the like.

[Separator]

The separator 23 partitions the positive electrode 21 and the negative electrode 22 from each other so as to prevent a short circuit of current due to a contact between the both electrodes, and also the separator 23 is impregnated with an electrolyte solution so as to allow a lithium ion to pass therethrough. This separator 23 is formed of, for example, a porous film made of a single layer of a polyolefin resin such as polypropylene (PP) or polyethylene (PE), a porous film formed by laminating these layers, non-woven fabric, or the like, or a laminate of two or more kinds of these porous films. The porous film of polyolefin is preferably used because its short circuit preventing effects are excellent and the safety of the battery can be enhanced by its shutdown effects.

Besides the polyolefin resin, the separator 23 can also be formed using a fluorinated resin such as polyvinylidene difluoride (PVdF) or polytetrafluoroethylene (PTFE), and a porous film in which these materials are mixed may also be used. Further, polytetrafluoroethylene (PTFE), polyvinylidene difluoride (PVdF), or the like may be applied on or adhered to a surface of the porous film of polypropylene (PP), polyethylene (PE), or the like. In a case of forming a porous layer of polytetrafluoroethylene (PTFE) or polyvinylidene difluoride (PVdF) over a surface of the porous film, inorganic particles of alumina (Al₂O₃), silica (SiO₂), or the like may be mixed in the porous layer.

[Electrolyte Solution]

The electrolyte solution contains an electrolyte salt and a solvent in which the electrolyte salt is dissolved.

The electrolyte salt contains, for example, one or two or more kinds of a light metal compound such as a lithium salt. Examples of this lithium salt include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethanesulfonate (LiCF₃SO₃), lithium tetrachloroaluminate (LiAlCl₄), dilithium hexafluorosilicate (Li₂SiF₆), lithium chloride (LiCl), lithium bromide (LiBr), and the like. Among them, at least one selected from the group consisting of lithium hexafluorophosphate, lithium tetrafluoroborate, lithium perchlorate, and lithium hexafluoroarsenate is preferable, and lithium hexafluorophosphate is more preferable.

Examples of the solvent include lactone-based solvents (e.g., γ-butyrolactone, γ-valerolactone, δ-valerolactone, and ε-caprolactone), carbonate-based solvents (e.g., ethylene carbonate, propylene carbonate, butylene carbonate, vinylene carbonate, dimethyl carbonate, ethyl methyl carbonate, and diethyl carbonate), ether-based solvents (e.g., 1,2-dimethoxyethane, 1-ethoxy-2-methoxyethane, 1,2-diethoxyethane, tetrahydrofuran, and 2-methyltetrahydrofuran), nitrile-based solvents (e.g., acetonitrile), and solvents such as sulfolane-based solvents, phosphoric acids, phosphate solvents, and pyrrolidones. As the solvent, it is possible to use any of the above examples alone or two or more examples mixed.

Further, as the solvent, it is preferable to use a mixture of cyclic carbonate and chain carbonate, and it is more preferable to contain a compound in which a part of or all of hydrogen in the cyclic carbonate or chain carbonate is fluorinated. As this fluorinated compound, it is preferable to use fluoroethylene carbonate (4-fluoro-1,3-dioxolan-2-one, FEC) or difluoroethylene carbonate (4,5-difluoro-1,3-dioxolan-2-one, DFEC). This is because, even in a case of using the negative electrode 22 containing a compound such as silicon (Si), tin (Sn), or germanium (Ge) as the negative electrode active material, it is possible to increase charge/discharge cycling characteristics. In particular, difluoroethylene carbonate is preferably used as the solvent because cycling characteristics improving effects are excellent.

The electrolyte solution may be a nonfluxional electrolyte by being held by a polymer compound. The polymer compound that holds the electrolyte solution therein may absorb the solvent to make a semi-solid state or a solid state, examples of which being a fluorine-based polymer compound (e.g., a copolymer containing polyvinylidene difluoride (PVdF), vinylidene fluoride (VdF), or hexafluoropropylene (HFP) in a repeating unit), an ether-based polymer compound (e.g., polyethylene oxide (PEO) or a crosslinked material containing polyethylene oxide (PEO)), a compound containing polyacrylonitrile (PAN), polypropylene oxide (PPO), or polymethyl methacrylate (PMMA) in a repeating unit. As the polymer compound, it is possible to use any of the above examples alone or two or more examples mixed.

In particular, in terms of a stable redox property, the fluorine-based polymer compound is preferable, and among them, the copolymer containing vinylidene fluoride and hexafluoropropylene as components is preferable. Further, this copolymer may also contain, as a component, a monoester of unsaturated diprotic acid such as monomethyl maleate (MMM), halogenated ethylene such as trifluorochloroethylene (PCTFE), a cyclic carbonate of an unsaturated compound such as vinylene carbonate (VC), an acrylic vinyl monomer containing an epoxy group, or the like. This is because higher characteristics can be obtained.

(2-2) Manufacturing Method of Cylindrical Battery

[Manufacturing Method of Positive Electrode]

The positive electrode 21 is manufactured by the manufacturing method described in the first embodiment, by using the positive electrode active material subjected to the deoxidizing treatment.

[Manufacturing Method of Negative Electrode]

A negative electrode mixture is prepared by mixing a negative electrode active material and a binder, and a paste-form negative electrode mixture slurry is prepared by dispersing this negative electrode mixture in a solvent such as N-methyl-2-pyrrolidone. Next, the negative electrode mixture slurry is applied on the negative electrode current collector 22A with a doctor blade, a bar coater, or the like, the solvent is dried, and the dried mixture is compression molded with a rolling press machine or the like, so that the negative electrode active material layer 22B is formed and the negative electrode 22 is manufactured.

The negative electrode active material layer 22B may be, for example, formed by any of a vapor phase method, a liquid phase method, a spraying method, or a baking method besides an applying method, or two or more of these methods may be combined. When the negative electrode active material layer 22B is formed by adopting a vapor phase method, a liquid phase method, a spraying method, a baking method or by combining two or more of these methods, it is preferable that the negative electrode active material layer 22B and the negative electrode current collector 22A are alloyed on at least a part of an interface therebetween. Specifically, it is preferable that, on the interface, constituent elements of the negative electrode current collector 22A are diffused into the negative electrode active material layer 22B, constituent elements of the negative electrode active material layer 22B are diffused into the negative electrode current collector 22A, or these constituent elements are mutually diffused into each other. This is because not only breakage to be caused by the expansion and shrinkage of the negative electrode active material layer 22B due to the charge/discharge can be suppressed, but also electron conductivity between the negative electrode active material layer 22B and the negative electrode current collector 22A can be enhanced.

Examples of the vapor phase method include a physical deposition method and a chemical deposition method, specifically a vacuum evaporation method, a sputtering method, an ion plating method, a laser abrasion method, a thermal chemical vapor deposition (CVD) method, and a plasma chemical vapor deposition method. As the liquid phase method, known techniques such as electroplating and electroless plating can be adopted. The baking method refers to, for example, a method in which after a particulate negative electrode active material is mixed with a binder and the like, the mixture is dispersed in a solvent and applied, and the applied material is then heat treated at a temperature higher than a melting point of the binder or the like. As for the baking method, known techniques can also be used, and examples thereof include an atmospheric baking method, a reaction baking method, and a hot press baking method.

[Preparation of Electrolyte Solution]

The electrolyte solution is prepared by dissolving a predetermined amount of electrolyte salt in the solvent.

[Composition of Cylindrical Battery]

The positive electrode lead 25 is attached to the positive electrode current collector 21A by welding or the like, and the negative electrode lead 26 is attached to the negative electrode current collector 22A by welding or the like. After that, the positive electrode 21 and the negative electrode 22 are wound with the separator 23 according to an embodiment of the present disclosure interposed therebetween to form the wound electrode body 20.

Next, a tip end of the positive electrode lead 25 is welded to the safety valve mechanism, and a tip end of the negative electrode lead 26 is welded to the battery can 11. Then, the surface where the wound electrode body 20 is wound is interposed between the pair of insulating plates 12a and 12b and housed in the inside of the battery can 11. After housing the wound electrode body 20 in the inside of the battery can 11, the electrolyte solution is injected into the inside of the battery can 11 and impregnated into the separator 23. After that, the battery cap 13, the safety valve mechanism including the safety valve 14 and the like, and the positive temperature coefficient element 17 are fixed to the open end portion of the battery can 11 by caulking via the gasket 18. In this manner, the cylindrical battery 10 shown in FIG. 1 according to an embodiment of the present disclosure is formed.

In the cylindrical battery 10, when charge is performed, for example, lithium ions are deintercalated from the positive electrode active material layer 21B and intercalated in the negative electrode active material layer 22B via the electrolyte solution with which the separator 23 is impregnated. Further, when discharge is performed, for example, lithium ions are deintercalated from the negative electrode active material layer 22B and intercalated in the positive electrode active material layer 21B via the electrolyte solution with which the separator 23 is impregnated.

<Effects>

The cylindrical battery 10 using the positive electrode 21 according to an embodiment of the present disclosure can have excellent cycling characteristics.

### 3. Third Embodiment

A third embodiment will show a thin battery using a positive electrode containing a positive electrode active material subjected to the deoxidizing treatment according to the first embodiment.

(3-1) Structure of Thin Battery

FIG. 3 shows a structure of a thin battery 42 according to the third embodiment. This thin battery 42 is a so-called laminated film type, in which a wound electrode body 30 to which a positive electrode lead 31 and a negative electrode lead 32 are attached is housed in the inside of a film-shaped package member 40 formed of a laminated film or the like.

Each of the positive electrode lead 31 and the negative electrode lead 32 is led out from the inside of the hermetically sealed package member 40 toward the outside in the same direction, for example. The positive electrode lead 31 and the negative electrode lead 32 are each formed using, for example, a metal material such as aluminum (Al), copper (Cu), nickel (Ni), or stainless steel (SUS), in a thin plate state or a network state.

The package member 40 is, for example, formed of a laminated film obtained by forming a resin layer on both surfaces of a metal layer. In the laminated film, an outer resin layer is formed on a surface of the metal layer, the surface being exposed to the outside of the battery, and an inner resin layer is formed on an inner surface of the battery, the inner surface being opposed to a power generation element such as the wound electrode body 30.

The metal layer plays a most important role to protect contents by preventing the entrance of moisture, oxygen, and light. Because of the lightness, stretching property, price, and easy processability, aluminum (Al) is most commonly used for the metal layer. The outer resin layer has beautiful appearance, toughness, flexibility, and the like, and is formed using a resin material such as nylon or polyethylene terephthalate (PET). Since the inner rein layers are to be melt by heat or ultrasonic waves to be welded to each other, a polyolefin resin is appropriately used for the inner resin layer, and cast polypropylene (CPP) is often used. An adhesive layer may be provided as necessary between the metal layer and each of the outer resin layer and the inner resin layer.

A depression portion in which the wound electrode body 30 is housed is formed in the package member 40 by deep drawing for example, in a direction from the inner resin layer side to the outer resin layer. The package member 40 is provided such that the inner resin layer is opposed to the wound electrode body 30. The inner resin layers of the package member 40 opposed to each other are adhered by welding or the like in an outer periphery portion of the depression portion. A contact film 41 is provided between the package member 40 and each of the positive electrode lead 31 and the negative electrode lead 32 for the purpose of increasing the adhesion between the inner resin layer of the package member 40 and each of the positive electrode lead 31 and the negative electrode lead 32 which are formed using metal materials. This contact film 41 is formed using a resin material having high adhesion to the metal material, examples of which being polyolefin resins such as polyethylene (PE), polypropylene (PP), modified polyethylene, and modified polypropylene.

Note that the metal layer of the package member 40 may also be formed using a laminated film having another lamination structure, or a polymer film such as polypropylene or a metal film, instead of the aluminum laminated film formed using aluminum (Al).

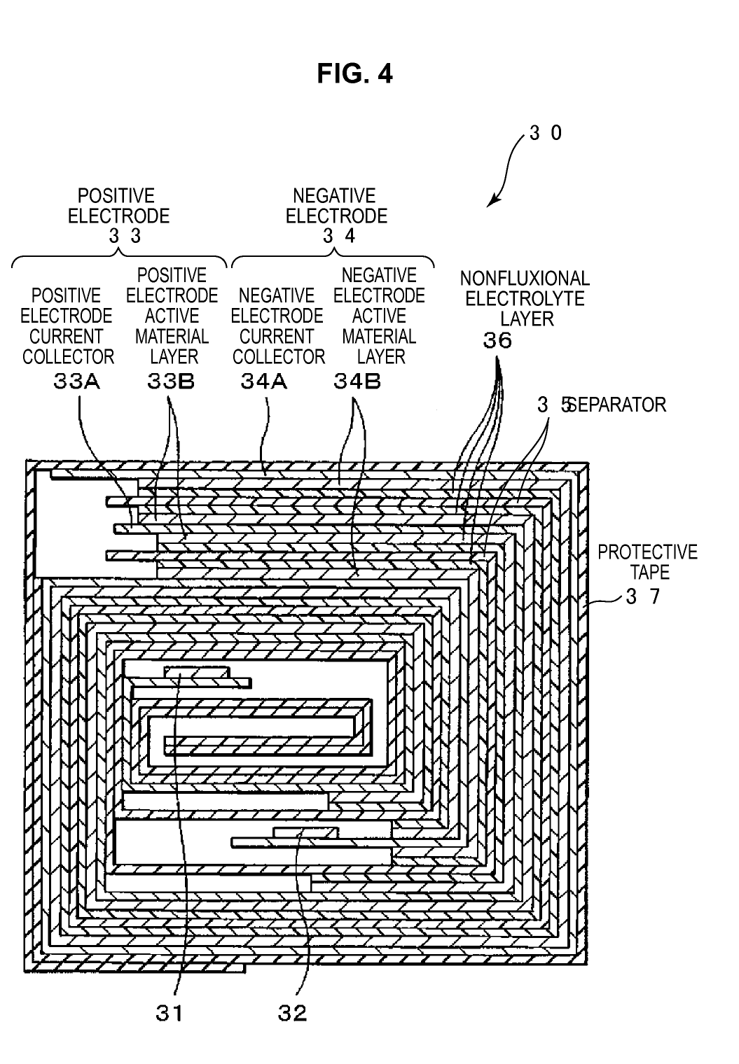

FIG. 4 shows a cross-sectional structure along an I-I line of the wound electrode body 30 shown in FIG. 3. This wound electrode body 30 is prepared by laminating a positive electrode 33 and a negative electrode 34 with a separator 35 and a nonfluxional electrolyte layer 36 interposed therebetween and winding the laminate, and an outermost peripheral portion thereof is protected by a protective tape 37 as necessary.

[Positive Electrode]

The positive electrode 33 has a structure in which a positive electrode active material layer 33B is provided on one of or both surfaces of a positive electrode current collector 33A. The structure of the positive electrode 33 including the positive electrode current collector 33A and the positive electrode active material layer 33B is the same as that of the above-described positive electrode 21 including the positive electrode current collector 21A and the positive electrode active material layer 21B in the first embodiment.

[Negative Electrode]

The negative electrode 34 has a structure in which a negative electrode active material layer 34B is provided on one of or both surfaces of a negative electrode current collector 34A, and the negative electrode active material layer 34B and the positive electrode active material layer 33B are opposed to each other. The structure of the negative electrode 34 including the negative electrode current collector 34A and the negative electrode active material layer 34B is the same as that of the above-described negative electrode 22 including the negative electrode current collector 22A and the negative electrode active material layer 22B in the second embodiment.

[Separator]

The separator 35 is the same as the above-described separator 23 in the second embodiment.

[Nonfluxional Electrolyte]

The nonfluxional electrolyte layer 36 includes an electrolyte solution and a polymer compound serving as a holding member holding the electrolyte solution therein. Further, the nonfluxional electrolyte layer 36 is an electrolyte layer in a semi-solid state or a solid state when the polymer compound absorbs a solvent. The nonfluxional electrolyte is preferable because high ion conductivity can be obtained and liquid spill from the battery can be prevented. Note that in the thin battery 42 in the third embodiment, the same electrolyte solution as in the second embodiment may be used instead of the nonfluxional electrolyte layer 36.

(3-2) Manufacturing Method of Thin Battery

This thin battery 42 can be manufactured in the following manner for example.

[Manufacturing Method of Positive Electrode]

The positive electrode is manufactured by the manufacturing method described in the first embodiment, by using the positive electrode active material subjected to the deoxidizing treatment.

[Manufacturing Method of Negative Electrode]

The negative electrode 34 can be formed by the same method as in the second embodiment.

[Composition of Thin Battery]

A precursor solution including an electrolyte solution, a polymer compound, and a mixed solvent is applied on both surfaces of each of the positive electrode 33 and the negative electrode 34, and the mixed solvent is then volatilized to form the nonfluxional electrolyte layer 36. Subsequently, the positive electrode lead 31 is attached to an end portion of the positive electrode current collector 33A by welding, and the negative electrode lead 32 is also attached to an end portion of the negative electrode current collector 34A by welding.

Subsequently, the positive electrode 33 and the negative electrode 34 each having the nonfluxional electrolyte layer 36 formed thereon are laminated with the separator 35 interposed therebetween to form a laminate, and then the laminate is wound in a longitudinal direction thereof and the protective tape 37 is adhered to an outermost peripheral portion to form the wound electrode body 30. Finally, for example, the wound electrode body 30 is interposed between the package members 40, and the outer periphery portions of the package members 40 are adhered to each other by means of heat fusion or the like, thereby enclosing the wound electrode body 30 therein. On that occasion, the contact film 41 is inserted between each of the positive electrode lead 31 and the negative electrode lead 32 and the package member 40. There is thus completed the thin battery 42 shown in FIGS. 3 and 4.

Alternatively, the thin battery 42 may be manufactured as follows. First of all, in the above-described manner, the positive electrode 33 and the negative electrode 34 are formed, and the positive electrode lead 31 and the negative electrode lead 32 are attached to the positive electrode 33 and the negative electrode 34, respectively. After that, the positive electrode 33 and the negative electrode 34 are laminated with the separator 35 interposed therebetween, the laminate is wound, and the protective tape 37 is adhered to an outermost peripheral portion, thereby forming the wound electrode body 30. Next, the wound electrode body 30 is interposed between the package members 40, the outer peripheral portions except for one side are adhered to each other by heat fusion to make a bag form, and the wound electrode body 30 is housed in the inside of the package member 40. Subsequently, an electrolyte composite including, in addition to an electrolyte solution, a monomer, which is a raw material of a polymer compound, a polymerization initiator, and another material such as a polymerization inhibitor as necessary is prepared and injected into the inside of the package member 40.

After the injection of the electrolyte composition, an opening of the package member 40 is hermetically sealed by heat fusion or the like under a vacuum atmosphere. Next, the monomer is heat polymerized to prepare a polymer compound, thereby forming the gel-form nonfluxional electrolyte layer 36, and compositing the thin battery 42 shown in FIGS. 3 and 4.

Further, in a case of using an electrolyte solution instead of the nonfluxional electrolyte layer 36 in the thin battery 42, the positive electrode 33 and the negative electrode 34 are laminated with the separator 35 interposed therebetween, the laminate is wound, and the protective tape 37 is adhered to the outermost peripheral portion, thereby forming the wound electrode body 30. Next, the wound electrode body 30 is interposed between the package members 40, outer peripheral portions except for one side are adhered to each other by heat fusion to make a bag form, and the wound electrode body 30 is housed in the inside of the package member 40. Subsequently, the electrolyte solution is injected into the inside of the packaging member 40, the opening of the packaging members 40 is hermetically sealed by heat fusion under a vacuum atmosphere, thereby compositing the thin battery 42.

(3-3) Other Examples of Thin Battery

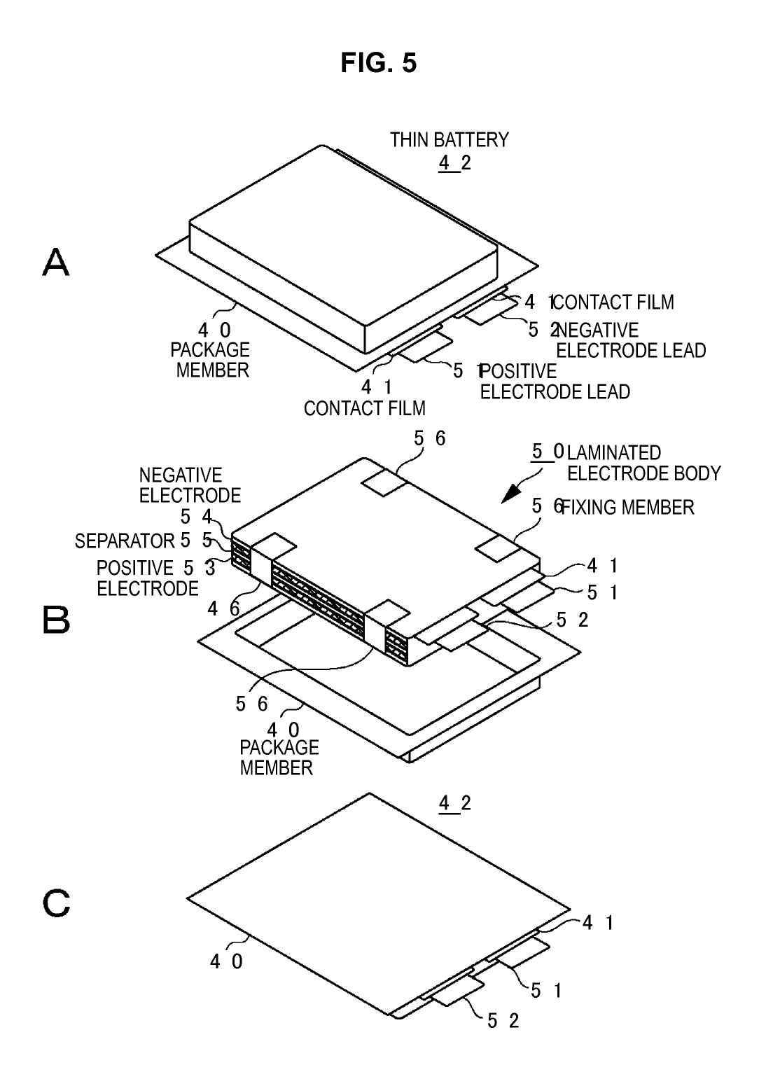

Although the third embodiment shows the thin battery 42 in which the wound electrode body 30 is packaged by the package member 40, as shown in FIGS. 5A to 5C, a laminated electrode body 50 may be used instead of the wound electrode body 30. FIG. 5A is an outline drawing showing the thin battery 42 in which the laminated electrode body 50 is housed. FIG. 5B is an exploded perspective view showing the state where the laminated electrode body 50 is to be housed in the inside of the package member 40. FIG. 5C is an outline view showing the appearance of the thin battery 42 shown in FIG. 5A from the bottom surface side.

As the laminated electrode body 50, the laminated electrode body 50 is used in which a rectangular positive electrode 53 and a rectangular negative electrode 54 are laminated with a separator 55 interposed therebetween and the laminate is fixed with a fixing member 56. A positive electrode lead 51 connected to the positive electrode 53 and a negative electrode lead 52 connected to the negative electrode 54 are led from the laminated electrode body 50, and the contact film 41 is provided between each of the positive electrode lead 51 and the negative electrode lead 52 and the package member 40.

Note that a method for forming the nonfluxional electrolyte layer (not shown), a method for injecting the electrolyte solution, and a method for heat fusion of the package member 40 are the same as those described in (3-2).

<Effects>

According to the third embodiment, the same effects as in the second embodiment can be obtained.

### 4. Fourth Embodiment

A fourth embodiment will show a coin battery 60 using a positive electrode containing a positive electrode active material subjected to the deoxidizing treatment according to the first embodiment.

(4-1) Structure of Coin Battery

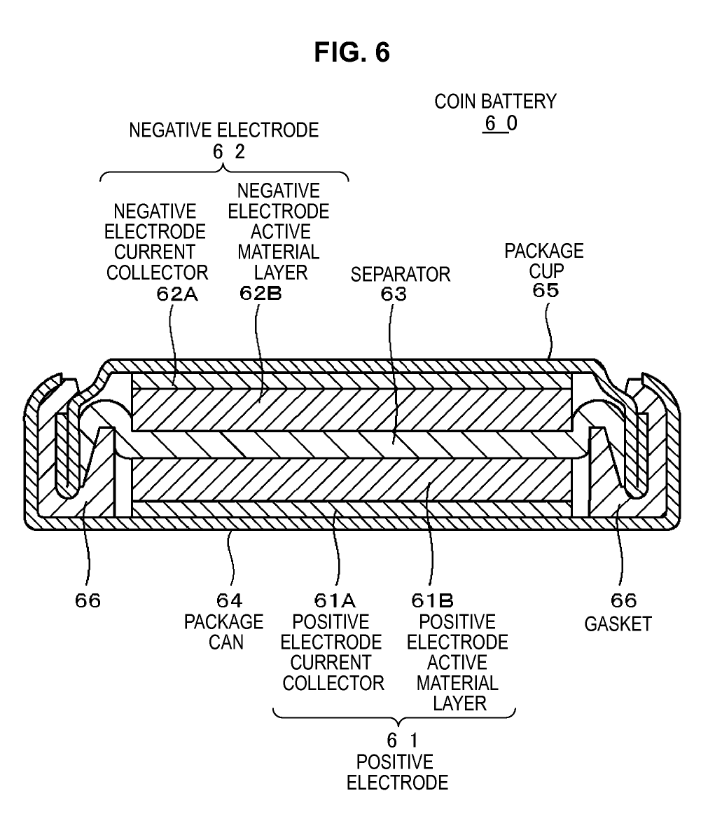

FIG. 6 is a cross-sectional view showing an example of a structure of the coin battery 60 according to the fourth embodiment.

[Positive Electrode]

A positive electrode 61 has a structure in which a positive electrode active material layer 61B is provided on a surface of a positive electrode current collector 61A, and has a pellet form stamped out to a disk form of a predetermined size. The structure of the positive electrode 61 including the positive electrode current collector 61A and the positive electrode active material layer 61B is the same as that of the above-described positive electrode 21 including the positive electrode current collector 21A and the positive electrode active material layer 21B in the first embodiment.

[Negative Electrode]

A negative electrode 62 has a structure in which a negative electrode active material layer 62B is provided on a surface of a negative electrode current collector 62A, and has a pellet form stamped out to a disk form of a predetermined size. The negative electrode active material layer 62B and the positive electrode active material layer 61B are opposed to each other. The structure of the negative electrode 62 including the negative electrode current collector 62A and the negative electrode active material layer 62B is the same as that of the above-described negative electrode 22 including the negative electrode current collector 22A and the negative electrode active material layer 22B in the second embodiment.

[Separator]

A separator 63 has the same structure as the above-described separator 23 in the second embodiment, and has a pellet form stamped out to a disk form of a predetermined size.

Further, a composition of an electrolyte solution impregnated into the separator 63 is the same as the composition of the electrolyte solution in the thin film battery 42.

(4-2) Manufacturing Method of Coin Battery

The coin battery 60 can be manufactured by adhering the positive electrode 61 to a package can 64, housing the negative electrode 62 in the inside of a package cup 65, laminating these structures with the separator 63 interposed therebetween impregnated with the electrolyte solution, and then calking the laminate via a gasket 66.

<Effects>

According to the fourth embodiment, the same effects as in the second embodiment can be obtained.

### 5. Fifth Embodiment

A fifth embodiment will show a battery pack including a battery (e.g., the cylindrical battery 10, the thin battery 42, or the coin battery 60) using a positive electrode including the positive electrode active material according to an embodiment of the present disclosure.

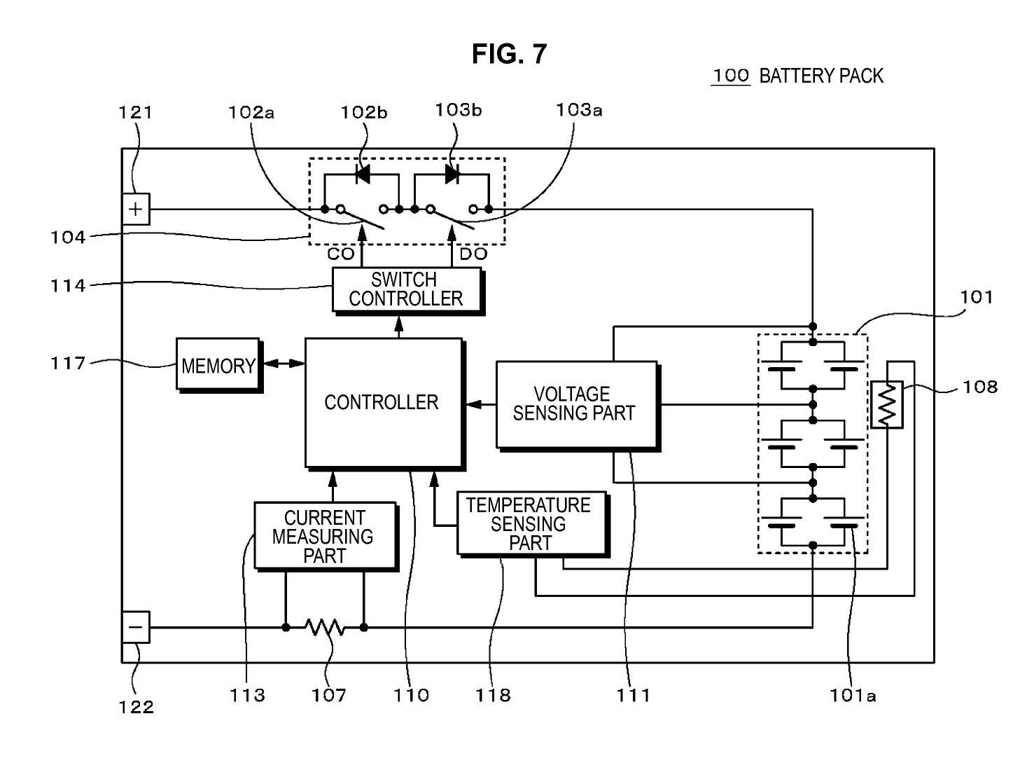

FIG. 7 is a block diagram showing a circuit configuration example in a case where the battery according to an embodiment of the present disclosure (e.g., the cylindrical battery 10, the thin battery 42, or the coin battery 60) is used in a battery pack 100. The battery pack 100 includes an assembled battery 101, a package, a switch part 104 including a charge control switch 102a and a discharge control switch 103a, a current sensing resistor 107, a temperature sensing element 108, and a controller 110.

Further, the battery pack 100 includes a positive electrode terminal 121 and a negative electrode terminal 122, and at the time of charge, the positive electrode terminal 121 and the negative electrode terminal 122 are connected to a positive electrode terminal and a negative electrode terminal of a battery charger, respectively, and charge is performed. Further, at the time of using an electronic device, the positive electrode terminal 121 and the negative electrode terminal 122 are connected to a positive electrode terminal and a negative electrode terminal of the electronic device, respectively, and discharge is performed.

The assembled battery 101 is formed by connecting a plurality of batteries 101a in series and/or in parallel. Each of the batteries 101a is the battery according to an embodiment of the present disclosure. Note that although FIG. 7 shows an example in which six batteries 101a are connected so as to have two parallel connections and three series connections (2P3S), any other connection can be adopted such as n parallel and m series (n and m are integers) connections.

The switch part 104 includes the charge control switch 102a, a diode 102b, the discharge control switch 103a, and a diode 103b, and is controlled by the controller 110. The diode 102b has a polarity that is reverse to charge current flowing in the direction from the positive electrode terminal 121 to the assembled battery 101 and forward to discharge current flowing in the direction from the negative electrode terminal 122 to the assembled battery 101. The diode 103b has a polarity that is forward to the charge current and reverse to the discharge current. Note that although an example is shown in which the switch part 104 is provided on a plus side, the switch part 104 may be provided on a minus side.

The charge control switch 102a is turned off when the battery voltage is an overcharge detection voltage and is controlled by the controller 110 so that charge current does not flow into a current path of the assembled battery 101. After the charge control switch 102a is turned off, only discharge is possible via the diode 102b. Further, when overcurrent flows during charge, the charge control switch 102a is turned off and controlled by the controller 110 so that charge current flowing in the current path of the assembled battery 101 is cut off.

The discharge control switch 103a is turned off when the battery voltage is an overdischarge detection voltage and is controlled by the controller 110 so that discharge current does not flow into the current path of the assembled battery 101. After the discharge control switch 103a is turned off, only charge is possible via the diode 103b. Further, when overcurrent flows during discharge, the discharge control switch 103a is turned off and controlled by the controller 110 so that discharge current flowing in the current path of the assembled battery 101 is cut off.

The temperature sensing element 108 is a thermistor for example, and is provided near the assembled battery 101, measures the temperature of the assembled battery 101, and supplies the measured temperature to the controller 110. A voltage sensing part 111 measures the voltage of the assembled battery 101 and of each battery 101a forming the assembled battery 101, A/D converts the measured voltage, and supplies the voltage to the controller 110. A current measuring part 113 measures current with the current sensing resistor 107, and supplies the measured current to the controller 110.

A switch controller 114 controls the charge control switch 102a and the discharge control switch 103a of the switch part 104, based on the voltage and current input from the voltage sensing part 111 and the current measuring part 113. When the voltage of any of the batteries 101a is the overcharge detection voltage or lower or the overdischarge detection voltage or lower, or when overcurrent flows rapidly, the switch controller 114 transmits a control signal to the switch part 104 to prevent overcharge, overdischarge, and overcurrent charge/discharge.

As a charge/discharge switch, for example, a semiconductor switch such as a MOSFET can be used. In this case, a parasitic diode of the MOSFET serves as the diodes 102b and 103b. In a case where a p-channel FET is used as the charge/discharge switch, the switch controller 114 supplies a control signal DO and a control signal CO to a gate of the charge control switch 102a and a gate of the discharge control switch 103a, respectively. In the case of the p-channel type, the charge control switch 102a and the discharge control switch 103a are turned on at a gate potential which is lower than a source potential by a predetermined value or more. That is, in normal charge and discharge operations, the charge control switch 102a and the discharge control switch 103a are made to be in an ON state by setting the control signals CO and DO to low levels.

Further, when performing overcharge or overdischarge, for example, the charge control switch 102a and the discharge control switch 103a are made to be in an OFF state by setting the control signals CO and DO to high levels.

A memory 117 is formed of a RAM or ROM, and is formed of an erasable programmable read only memory (EPROM), which is a volatile memory, for example. The memory 117 stores, in advance, the value calculated in the controller 110, the internal resistance value of the battery in an initial state of each of the batteries 101a measured at a stage in a manufacturing process, and the like, which are rewritable as necessary. Further, by storing a full charge capacity of the battery 101a, the memory 117 can calculate the remaining capacity together with the controller 110, for example.

A temperature sensing part 118 measures the temperature with use of the temperature sensing element 108, controls charge/discharge at the time of abnormal heat generation, and corrects the calculation of the remaining capacity.

### 6. Sixth Embodiment

A sixth embodiment will show devices such as an electronic device, an electric vehicle, and a power storage device each incorporating the battery according to any of the second to fourth embodiments or the battery pack 100 according to the fifth embodiment. Each battery and the battery pack 100 described in any of the second to fifth embodiments can be used to supply power to the devices such as an electronic device, an electric vehicle, and a power storage device.

Examples of the electronic device include a laptop personal computer, a PDA (mobile information device), a mobile phone, a cordless extension, a video movie, a digital still camera, an e-book reader, an electronic dictionary, a music player, a radio, a headphone, a game machine, a navigation system, a memory card, a pacemaker, a hearing aid, an electric tool, an electric razor, a refrigerator, an air conditioner, a television set, a stereo, a water heater, a microwave, a dishwasher, a washer, a drier, a lighting device, a toy, a medical device, a robot, a road conditioner, a traffic light, and the like.

Further, examples of the electric vehicle include a railway train, a golf cart, an electric cart, an electric car (including a hybrid car), and the like. Each battery and the battery pack 100 described in any of the second to fifth embodiments can be used as a power source for driving these vehicles or as a supplementary power source.

Examples of the power storage device include a power source for power storage for buildings such as houses or for power generation equipment, and the like.

From the above application examples, the following will show a specific example of a power storage system using the power storage device using the battery according to an embodiment of the present disclosure.

This power storage system can have the following structure for example. A first power storage system is a power storage system in which the power storage device is charged with a power generation device which generates power from renewable energy. A second power storage system is a power storage system which includes the power storage device and supplies power to an electronic device connected to the power storage device. A third power storage system is an electronic device which is supplied with power from the power storage device. These power storage systems are each implemented as a system to supply power efficiently in association with an external power supply network.

Further, a fourth power storage system is an electric vehicle including a conversion device which converts power supplied from the power storage device to driving power of a vehicle, and a control device which performs information processing about vehicle control based on information about the power storage device. A fifth power storage system is a power system including a power information transmitting/receiving part which transmits/receives signals to/from other devices via a network, and controls charge/discharge of the power storage device based on information received by the transmitting/receiving part. A sixth power storage system is a power system which enables power supply from the power storage device and power supply to the power storage device from a power generation device or a power network. The following will show the power storage system.

(6-1) Home Power Storage System as Application Example

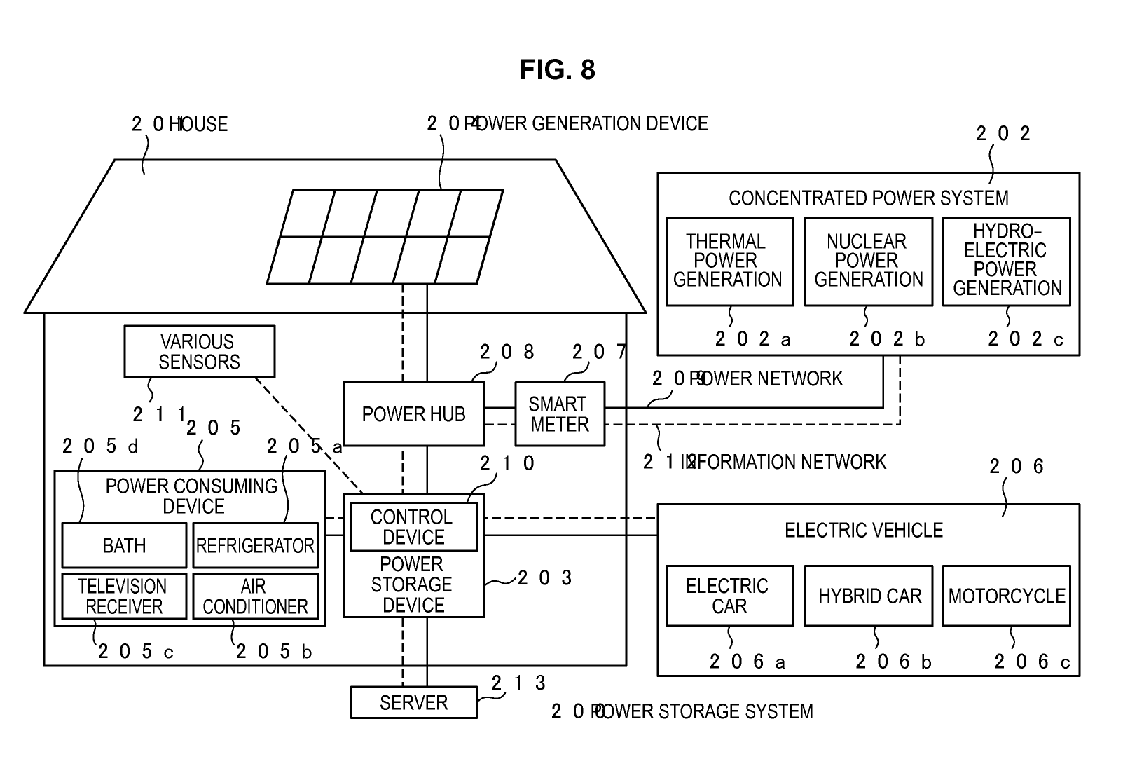

An example in which the power storage device using the battery according to an embodiment of the present disclosure is used for a home power storage system will be described with reference to FIG. 8. For example, in a power storage system 200 for a house 201, power is supplied to the power storage device 203 from a concentrated power system 202 including thermal power generation 202a, nuclear power generation 202b, hydroelectric power generation 202c, and the like, via a power network 209, an information network 212, a smart meter 207, a power hub 208, and the like. As the power storage device 203, the above-described battery or battery pack according to an embodiment of the present disclosure is used. Further, power is supplied to the power storage device 203 from an independent power source such as a home power generation device 204. Power supplied to the power storage device 203 is stored, and power to be used in the house 201 is fed with use of the power storage device 203. The same power storage system can be used not only in the house 201 but also in a building.

The house 201 is provided with the home power generation device 204, a power consumption device 205, the power storage device 203, a control device 210 which controls each device, the smart meter 207, and sensors 211 which acquires various pieces of information. The devices are connected to each other by the power network 209 and the information network 212. As the home power generation device 204, a solar cell, a fuel cell, or the like is used, and generated power is supplied to the power consumption device 205 and/or the power storage device 203. Examples of the power consumption device 205 include a refrigerator 205a, an air conditioner 205b, a television receiver 205c, a bath 205d, and the like. Examples of the power consumption device 205 further include an electric vehicle 206 such as an electric car 206a, a hybrid car 206b, or a motorcycle 206c.

For the power storage device 203, the battery according to an embodiment of the present disclosure is used. The battery according to an embodiment of the present disclosure may be formed of the above-described lithium ion secondary battery for example. Functions of the smart meter 207 include measuring the used amount of commercial power and transmitting the measured used amount to a power company. The power network 209 may be any one or more of DC power supply, AC power supply, and contactless power supply.

Examples of the various sensors 211 include a motion sensor, an illumination sensor, an object detecting sensor, a power consumption sensor, a vibration sensor, a touch sensor, a temperature sensor, an infrared sensor, and the like. Information acquired by the various sensors 211 is transmitted to the control device 210. With the information from the sensors 211, weather conditions, people conditions, and the like are caught, and the power consumption device 205 is automatically controlled so as to make the energy consumption minimum. Further, the control device 210 can transmit information about the house 201 to an external power company via the Internet, for example.

The power hub 208 performs processes such as branching off power lines and DC/AC conversion. Examples of communication schemes of the information network 212 connected to the control device 210 include a method using a communication interface such as UART (Universal Asynchronous Receiver/Transceiver), and a method using a sensor network according to a wireless communication standard such as Bluetooth, ZigBee, or Wi-Fi. A Bluetooth scheme can be used for multimedia communication, and one-to-many connection communication can be performed. ZigBee uses a physical layer of IEEE (Institute of Electrical and Electronics Engineers) 802.15.4. IEEE802.15.4 is the name of a near-field wireless network standard called PAN (Personal Area Network) or W (Wireless) PAN.

The control device 210 is connected to an external server 213. The server 213 may be managed by any of the house 201, an electric company, and a service provider. Examples of information transmitted and received by the server 213 include power consumption information, life pattern information, electric fee, weather information, natural disaster information, and information about power trade. Such information may be transmitted and received by the power consumption device 205 (e.g., the television receiver 205c) in the house, or may be transmitted and received by a device (e.g., a mobile phone) outside the house. Further, such information may be displayed on a device having a display function, such as the television receiver 205c, the mobile phone, or the PDA (Personal Digital Assistant).

The control device 210 controlling each part is configured with a CPU (Central Processing Unit), a RAM (Random Access Memory), a ROM (Read Only Memory), and the like, and is stored in the power storage device 203 in this example. The control device 210 is connected to the power storage device 203, the home power generation device 204, the power consumption device 205, the various sensors 211, and the server 213 via the information network 212, and has a function of adjusting the used amount of commercial power and the power generation amount, for example. Note that the control device 210 may further have a function of performing power trade in the power market.

As described above, power generated by not only the concentrated power system 202 such as the thermal power generation 202a, the nuclear power generation 202b, and the hydroelectric power generation 202c, but also the home power generation device 204 (solar power generation or wind power generation) can be stored in the power storage device 203. Therefore, even when the power generated by the home power generation device 204 varies, the amount of power supplied to the outside can be constant, or only necessary discharge can be controlled. For example, power generated by the solar power generation can be stored in the power storage device 203 and also inexpensive power at midnight can be stored in the power storage device 203 during nighttime, so that power stored in the power storage device 203 can be discharged and used when the power fee is expensive during daytime.

Note that although this example shows the control device 210 housed in the inside of the power storage device 203, the control device 210 may be housed in the inside of the smart meter 207 or configured independently. Further, the power storage system 200 may be used for a plurality of houses in a multiple dwelling house or a plurality of separate houses.

(6-2) Power Storage System in Vehicle as Application Example

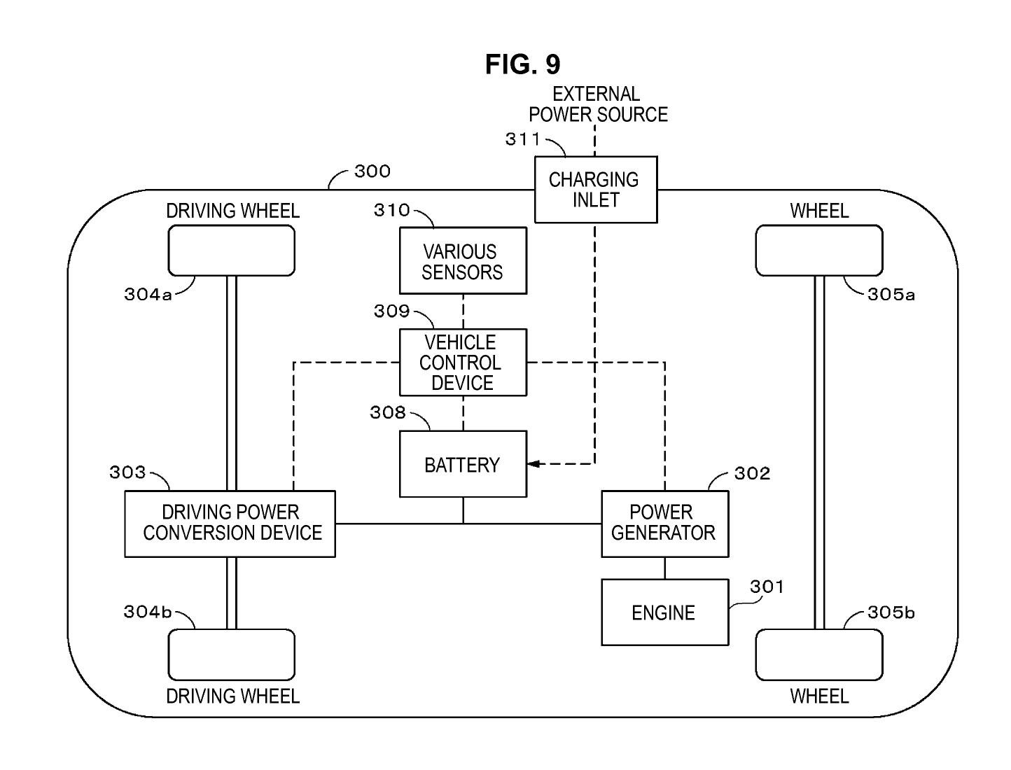

An example in which an embodiment of the present disclosure is applied to a power storage system for vehicles will be described with reference to FIG. 9. FIG. 9 schematically shows an example of a structure of a hybrid vehicle employing a series hybrid system to which an embodiment of the present disclosure is applied. The series hybrid system is a car which runs with a driving power conversion device using power generated by a power generator driven by an engine or power obtained by storing the power in a battery.

A hybrid vehicle 300 incorporates an engine 301, a power generator 302, a driving power conversion device 303, driving wheels 304a and 304b, wheels 305a and 305b, a battery 308, a vehicle control device 309, various sensors 310, and a charging inlet 311. For the battery 308, the battery or the battery pack according to embodiments of the present disclosure is used.

The hybrid vehicle 300 runs by using the driving power conversion device 303 as a power source. One of examples of the driving power conversion device 303 is a motor. Power in the battery 308 drives the driving power conversion device 303, and the rotating power of the driving power conversion device 303 is transmitted to the driving wheels 304a and 304b. Note that by using DC/AC conversion or AC/DC conversion in a necessary portion, an alternate current motor or a direct current motor can be used for the driving power conversion device 303. The various sensors 310 control the number of engine rotation via the vehicle control device 309 and controls the aperture of an unshown throttle valve (throttle aperture). The various sensors 310 include a speed sensor, an acceleration sensor, a sensor of the number of engine rotation, and the like.

The rotating power of the engine 301 is transmitted to the power generator 302, and power generated by the power generator 302 with the rotating power can be stored in the battery 308.

When the hybrid vehicle 300 reduces the speed with an unshown brake mechanism, the resisting power at the time of the speed reduction is added to the driving power conversion device 303 as the rotating power, and regenerative power generated by the driving power conversion device 303 with this rotating power is stored in the battery 308.

The battery 308 can be connected to an external power source of the hybrid vehicle 300, and accordingly, power can be supplied from the external power source by using the charging inlet 311 as an input inlet, and the received power can be stored.

Although not shown, an information processing device which performs information processing about vehicle control based on information about the battery may be provided. Examples of such an information processing device include an information processing device which displays the remaining battery based on information about the remaining battery.

Note that the above description is made by taking an example of the series hybrid car which runs with a motor using power generated by a power generator driven by an engine or power obtained by storing the power in a battery. However, an embodiment of the present disclosure can also be applied effectively to a parallel hybrid car which uses the output of an engine and a motor as the driving power source and switches three modes as appropriate: driving with the engine only; driving with the motor only; and driving with the engine and the motor. Further, an embodiment of the present disclosure can also be applied effectively to a so-called electric vehicle which runs by being driven with a driving motor only, without an engine.

### Examples

The following examples will show embodiments of the present disclosure in detail. Note that structures of the embodiments of the present disclosure are not limited to the following examples.

<Samples 1-1 to 1-12>

Samples 1-1 to 1-12 were formed using either a positive electrode active material obtained by performing deoxidizing treatment on a lithium transition metal composite oxide or a positive electrode active material on which the deoxidizing treatment was not performed, and battery characteristics thereof were evaluated.

<Sample 1-1>

[Fabrication of Positive Electrode]

Into a lithium-nickel-cobalt-aluminum composite oxide (LiNi_{0.8}CO_{0.15}Al_{0.05}O₂), which is a lithium transition metal composite oxide, carbon (Ketjen black), which is also used as a conductive material, was mixed as a reducing agent. This mixture was baked at 550° C. under a nitrogen atmosphere for 300 minutes. Thus, a positive electrode active material in which oxygen was extracted from the lithium transition metal composite oxide (LiNi_{0.8}Co_{0.15}Al_{0.05}O₂) was obtained. The mixed amount of carbon was 5 parts with respect to 95 parts of the lithium transition metal composite oxide (lithium transition metal composite oxide:reducing agent=95:5 in mass ratio). Note that the temperature at which carbon starts reducing is 400° C.

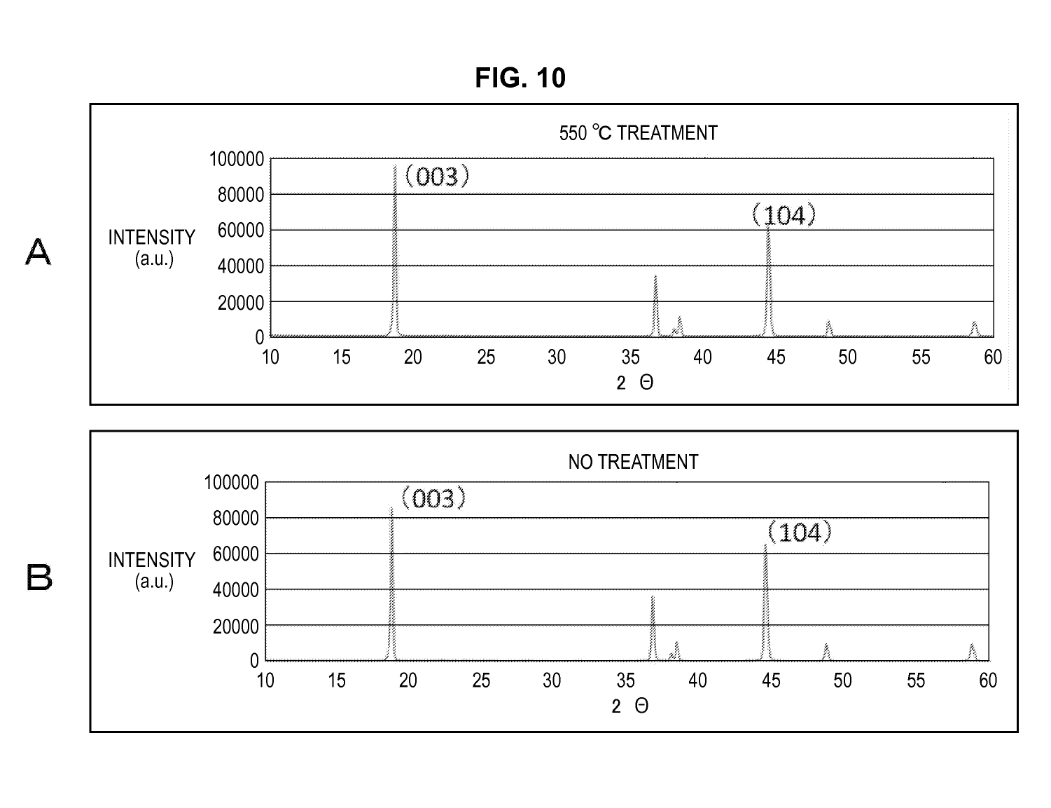

The positive electrode active material subjected to the deoxidizing treatment was subjected to an X-ray diffraction (XRD) measurement. In the X-ray diffraction measurement, peak intensity I₀₀₃ of a peak attributed to a (003) plane and peak intensity I₁₀₄ of a peak attributed to a (104) plane were measured, and a ratio thereof I₀₀₃/I₁₀₄ was calculated. A graph of measurement results obtained by the X-ray diffraction measurement on the sample 1-1 is shown in FIG. 10A. The peak intensity ratio I₀₀₃/I₁₀₄ of the sample 1-1 was 0.75.

A positive electrode mixture was prepared by mixing 97.5 mass % of the positive electrode active material subjected to the deoxidizing treatment as described above and 2.5 mass % of polyvinylidene difluoride (PVdF) which is a binder. Note that the positive electrode active material contained a small amount of carbon which was mixed as a reducing agent and remained without reacting with oxygen at the time of the deoxidizing treatment. In 97.5 mass % of the positive electrode active material, the positive electrode active material was 96.7 mass % and carbon was 0.8 mass %. This positive electrode mixture was dispersed in N-methyl-2-pyrrolidone (NMP), which is a solvent, so that a paste-form positive electrode mixture slurry was obtained. Then, the positive electrode mixture slurry was applied uniformly on both surfaces of a positive electrode current collector formed using belt-like aluminum (Al) foil with a thickness of 15 μm and was dried, and the dried slurry was compression molded with a rolling press machine, so that a positive electrode active material layer was formed and a positive electrode was fabricated. On one end of the positive electrode, a portion where the positive electrode active material layer was not formed and the positive electrode current collector was exposed was formed, and a positive electrode lead formed using aluminum was attached to the exposed positive electrode current collector.

The heat generation amount of the thus fabricated positive electrode with respect to temperature was measured by differential scanning calorimetry (DSC). The heat generation amount of the positive electrode was measured with use of a differential scanning calorimeter (produced by Seiko Instruments Inc., DSC EXSTAR6000). The measurement results are shown in a graph denoted by reference numeral 411 in FIG. 12.

[Fabrication of Negative Electrode]

A negative electrode mixture was prepared by mixing 87 mass % of silicon (Si) powder, which is a negative electrode active material, 5 mass % of polyvinylidene difluoride (PVdF), which is a binder, and 8 mass % of carbon, which is a conductive material. This negative electrode mixture was dispersed in N-methyl-2-pyrrolidone (NMP) which is a solvent, so that a paste-form negative electrode mixture slurry was obtained. Then, the negative electrode mixture slurry was applied on both surfaces of a negative electrode current collector formed using copper (Cu) foil with a thickness of 15 μm and was dried, and the dried slurry was compression molded with a rolling press machine, so that a negative electrode active material layer was formed and a negative electrode was fabricated. On one end of the negative electrode, a portion where the negative electrode active material layer was not formed and the negative electrode current collector was exposed was formed, and a negative electrode lead formed using nickel was attached to the exposed negative electrode current collector.

[Preparation of Electrolyte Solution]

As an electrolyte solution, a mixture containing lithium hexafluorophosphate (LiPF₆) as an electrolyte salt in a mixed solvent obtained by mixing ethylene carbonate (EC), diethyl carbonate (DEC), and vinylene carbonate (VC) so that the volume ratio thereof was EC:DEC:VC=30:60:10 was used. The concentration of lithium hexafluorophosphate (LiPF₆) in the electrolyte solution was 1 mol/dm³.

[Separator]

As a separator, a 23 μm thick porous film having a laminate structure in which both surfaces of a porous film of polyethylene were interposed between porous films of polypropylene.

[Composition of Battery]

The positive electrode and the negative electrode were laminated with the separator interposed therebetween, so that a lamination was obtained in which the positive electrode, the separator, the negative electrode, and the separator were laminated in this order. In this case, the positive electrode and the negative electrode were laminated in a manner that the positive electrode lead connected to the positive electrode and the negative electrode lead connected to the negative electrode are led from the respective surfaces where the lamination was wound. Subsequently, the lamination was wound in the longitudinal direction, and a terminal portion of the wound lamination was fixed, so that a wound electrode body was obtained.

Next, a battery can formed using iron plated with nickel was prepared, surfaces where the wound electrode body was wound were interposed between a pair of insulating plates, and the negative electrode lead was welded to a battery can. Further, the positive electrode lead was welded to a safety valve mechanism electrically connected to a battery cap, so that the wound electrode body was housed in the inside of the battery can. Subsequently, the electrolyte solution was injected into the inside of the battery can by a low pressure method. Next, by calking the battery cap and the battery can together via a gasket whose surface is coated with asphalt, the safety valve mechanism, a positive temperature coefficient element, and the battery cap were fixed and the battery can was hermetically sealed, so that a cylindrical battery was fabricated.

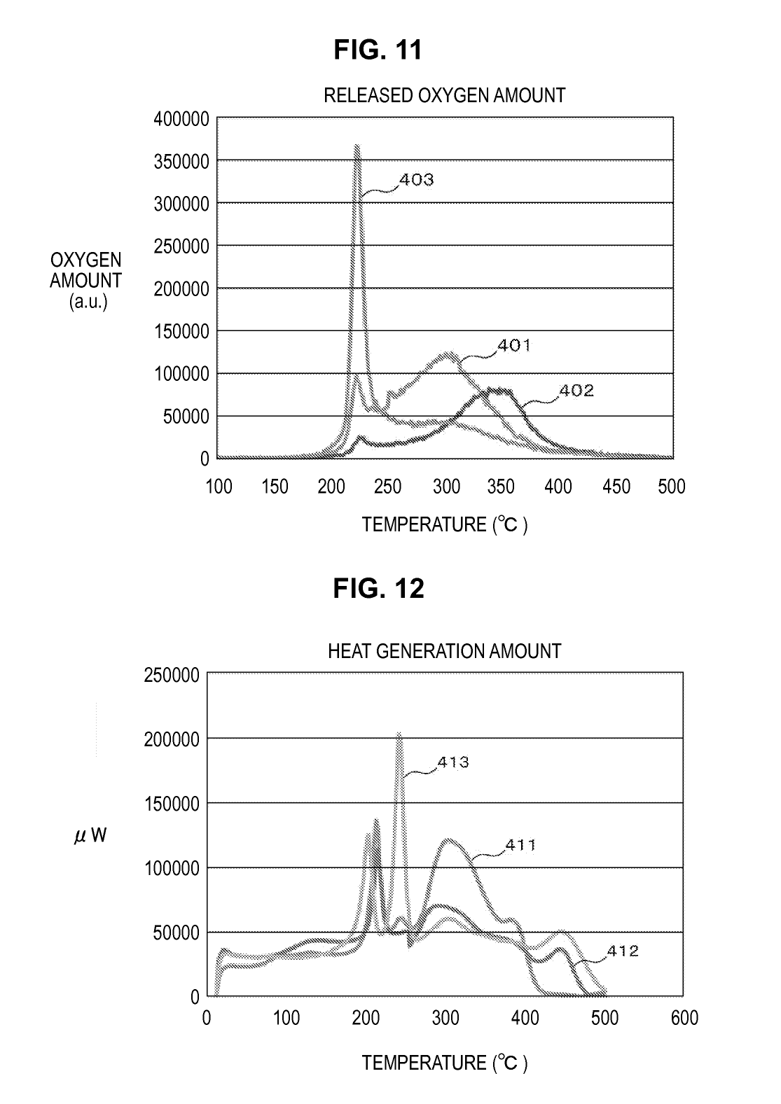

The cylindrical battery was subjected to fixed current charge under a 23° C. atmosphere and a 1C rate condition, the fixed current charge was switched to fixed voltage charge when the battery voltage became 4.2 V, and the fixed voltage charge was performed until the ending current value became 50 mA, so that a charge state was made. The battery in the charge state was decomposed and the oxygen generation amount of the positive electrode was measured with use of a gas chromatography/mass spectrometer provided with a pyrolyzer in a sample insertion point (Py-GC/MS) (pyrolyzer: DOUBLE SHOT PYROLYZER PY-2010D produced by Frontier Laboratories Ltd., gas chromatograph: 5890 SERIES II 5890E produced by Hewlett-Packard Company, and mass spectrometer: 5972 SERIES MASS SELECTIVE DETECTOR produced by Hewlett-Packard Company). In the measurement, gases generated in a heating process were introduced to the mass spectrometer successively and selectively, so that the oxygen generation amount with respect to the temperature was measured. At this time, the first peak of an oxygen generation temperature in the heating process appeared at 230° C., and the second peak thereof appeared at 300° C. A graph denoted by reference numeral 401 in FIG. 11 shows the oxygen generation amount in the sample 1-1.

The total amount of the oxygen generation amount until the first peak was 5,051,678, and the total amount of the oxygen generation amount from the first peak to the second peak was 5,619,953. Here, the oxygen generation amounts were calculated from the integrated value (area) of the graph of the oxygen generation amount shown by the graph denoted by reference numeral 401 in FIG. 11.

<Sample 1-2>

A cylindrical battery was fabricated in the same manner as the sample 1-1 except that the lithium transition metal composite oxide subjected to the deoxidizing treatment was lithium nickelate (LiNiO₂) and the baking temperature was 560° C. The peak intensity ratio I₀₀₃/I₁₀₄ of the sample 1-2 was 0.75, and the first peak and the second peak of the oxygen generation temperature in the heating process appeared at 240° C. and 290° C., respectively. The oxygen generation amounts were as shown in Table 1 below.

<Sample 1-3>

A cylindrical battery was fabricated in the same manner as the sample 1-1 except that the lithium transition metal composite oxide subjected to the deoxidizing treatment was lithium-nickel-manganese-cobalt composite oxide (LiNi_{0.5}Mn_{0.25}Co_{0.25}O₂) and the baking temperature was 580° C. The peak intensity ratio I₀₀₃/I₁₀₄ of the sample 1-3 was 0.75, and the first peak and the second peak of the oxygen generation temperature in the heating process appeared at 250° C. and 420° C., respectively. The oxygen generation amounts were as shown in Table 1 below.

<Sample 1-4>

A cylindrical battery was fabricated in the same manner as the sample 1-1 except that the lithium transition metal composite oxide subjected to the deoxidizing treatment was lithium-nickel-cobalt-aluminum composite oxide (LiNi_{1/3}Co_{1/3}Al_{1/3}O₂) and the baking temperature was 585° C. The peak intensity ratio I₀₀₃/I₁₀₄ of the sample 1-4 was 0.75, and the first peak and the second peak of the oxygen generation temperature in the heating process appeared at 245° C. and 430° C., respectively. The oxygen generation amounts were as shown in Table 1 below.

<Sample 1-5>

A cylindrical battery was fabricated in the same manner as the sample 1-1 except that the lithium transition metal composite oxide subjected to the deoxidizing treatment was lithium-nickel-cobalt-aluminum composite oxide (LiNi_{0.7}Co_{0.19}Al_{0.01}O₂). The peak intensity ratio I₀₀₃/I₁₀₄ of the sample 1-5 was 0.73, and the first peak and the second peak of the oxygen generation temperature in the heating process appeared at 230° C. and 240° C., respectively. The oxygen generation amounts were as shown in Table 1 below.

<Sample 1-6>

A cylindrical battery was fabricated in the same manner as the sample 1-1 except that the lithium transition metal composite oxide subjected to the deoxidizing treatment was lithium cobalt oxide (LiCoO₂) and the baking temperature was 600° C. The peak intensity ratio I₀₀₃/I₁₀₄ of the sample 1-6 was 0.65, and the first peak and the second peak of the oxygen generation temperature in the heating process appeared at 270° C. and 380° C., respectively. The oxygen generation amounts were as shown in Table 1 below.

<Sample 1-7>

A cylindrical battery was fabricated in the same manner as the sample 1-1 except that the lithium transition metal composite oxide was not subjected to the deoxidizing treatment (mixing of carbon and baking). As shown in Table 1, the peak intensity ratio I₀₀₃/I₁₀₄ of the sample 1-7 by an X-ray diffraction measurement was 0.87, the first peak of the oxygen generation temperature in the heating process appeared in a range of 230° C., but the second peak did not appear.

FIG. 10B shows a graph of measurement results obtained by the X-ray diffraction measurement on the positive electrode active material of the sample 1-7. A graph denoted by reference numeral 403 in FIG. 11 shows the oxygen generation amount in the sample 1-7. Further, a graph denoted by reference numeral 413 in FIG. 12 shows the heat generation amount of the positive electrode with respect to the temperature measured by differential scanning calorimetry in the sample 1-7.

<Samples 1-8 to 1-12>

Five cylindrical batteries were fabricated in the same manner as the samples 1-2 to 1-6, respectively, except that the lithium transition metal composite oxide was not subjected to the deoxidizing treatment (mixing of carbon and baking). As shown in Table 1, the peak intensity ratios I₀₀₃/I₁₀₄ of the samples 1-8 to 1-12 by X-ray diffraction measurements were 0.82 to 0.88, and the first peaks of the oxygen generation temperature in the heating process appeared in a range of 230° C. to 270° C., but the second peaks did not appear.

[Evaluation of Batteries]

(a) Initial Charge/Discharge Efficiency

Prior to investigation of the initial charge/discharge efficiency, in order to stabilize the battery state, one cycle charge/discharge was performed under the following conditions. The cylindrical battery of each sample was subjected to fixed current charge under a 23° C. atmosphere and a 1° C. rate condition, the fixed current charge was switched to fixed voltage charge when the battery voltage became 4.2 V, and the fixed voltage charge was performed until the ending current value became 50 mA, so that a full charge state was made. After that, fixed current discharge was performed until the battery voltage became 2.5 V under the 1C rate condition.

Subsequently, charge was performed under the same condition, and the charge capacity was measured. Then, discharge was performed under the same condition, and the discharge capacity was measured. The initial charge/discharge efficiency was calculated from the following equation.

Initial charge/discharge efficiency[%]=(Discharge capacity/Charge capacity)×100

(b) Highest Temperature on Battery Surface

The cylindrical battery of each sample was subjected to fixed current charge under a 23° C. atmosphere and a 1C rate condition, the fixed current charge was switched to fixed voltage charge when the battery voltage became 4.2 V, and the fixed voltage charge was performed until the ending current value became 50 mA, so that a full charge state was made. After that, the cylindrical batteries in the full charge state were stored under a 135° C. atmosphere for one hour. During the storing, the temperature on a side surface of the battery can (battery surface) was measured with a thermocouple until the battery was taken out, and the highest temperature was measured. Although the accurate highest temperature was not able to be measured when the battery was exploded before one hour passed and the thermocouple became out of contact with the battery surface during the measurement, the safety of such a battery was determined to be not sufficient.

Evaluation results are shown in Table 1 below. Note that the evaluation is based on the following evaluation standard (the same applies to Tables 2 to 5).

A: The initial charge/discharge efficiency is excellent, the highest temperature on the battery surface is low, and the safety is high

B: The initial charge/discharge efficiency is low, the highest temperature on the battery surface is low, and the safety is high

C: The highest temperature on the battery surface is high and the appearance of battery is partly changed

D: The highest temperature of the battery surface was not able to be measured and the safety is insufficient due to explosion of the battery or the like.

Note that the initial charge/discharge efficiency was determined by using 80% as a reference value. This reference value was set based on performance demanded for household lithium ion secondary batteries.

TABLE 1

Positive Electrode

| | Composite Oxide | | Mass Ratio | Baking | |
|---|---|---|---|---|---|
| | Before Deoxidizing | Reducing | Active Material/ | Temp. | XRD |
| | Treatment | Agent | Reducing Agent | [° C.] | Ratio |
| Sample 1-1 | LiNi_{0.8}Co_{0.15}Al_{0.05}O₂ | Carbon | 95/5 | 550 | 0.75 |
| Sample 1-2 | LiNiO₂ | Carbon | 95/5 | 560 | 0.75 |
| Sample 1-3 | LiNi_{0.5}Mn_{0.25}Co_{0.25}O₂ | Carbon | 95/5 | 580 | 0.75 |
| Sample 1-4 | LiNi_{1/3}Co_{1/3}Al_{1/3}O₂ | Carbon | 95/5 | 585 | 0.75 |
| Sample 1-5 | LiNi_{0.7}Co_{0.19}Al_{0.01}O₂ | Carbon | 95/5 | 550 | 0.73 |
| Sample 1-6 | LiCoO₂ | Carbon | 95/5 | 600 | 0.65 |
| Sample 1-7 | LiNi_{0.8}Co_{0.15}Al_{0.05}O₂ | — | 95/0 | — | 0.87 |
| Sample 1-8 | LiNiO₂ | — | 95/0 | — | 0.87 |
| Sample 1-9 | LiNi_{0.5}Mn_{0.25}Co_{0.25}O₂ | — | 95/0 | — | 0.87 |
| Sample 1-10 | LiNi_{1/3}Co_{1/3}Al_{1/3}O₂ | — | 95/0 | — | 0.87 |
| Sample 1-11 | LiNi_{0.7}Co_{0.19}Al_{0.01}O₂ | — | 95/0 | — | 0.88 |
| Sample 1-12 | LiCoO₂ | — | 95/0 | — | 0.82 |

| | Positive Electrode | | | | | | | |
|---|---|---|---|---|---|---|---|---|
| | Oxygen | | | | Negative | | | |
| | Generation | | Oxygen Generation | | Electrode | Initial | Highest Temp. | |
| | Temp. [° C.] | | Amount (a.u.) | | Active | Efficiency | On Battery | |
| | 1st Peak | 2nd Peak | 1st Peak | 2nd Peak | Material | [%] | Surface [° C.] | Evaluation |
| Sample 1-1 | 230 | 300 | 5,051,678 | 5,619,953 | Si | 87.0 | 167 | A |
| Sample 1-2 | 240 | 290 | 4,819,734 | 5,516,647 | Si | 87.0 | 167 | A |
| Sample 1-3 | 250 | 420 | 4,653,079 | 6,472,213 | Si | 88.0 | 165 | A |
| Sample 1-4 | 245 | 430 | 4,016,795 | 6,866,413 | Si | 88.5 | 166 | A |
| Sample 1-5 | 230 | 240 | 5,164,711 | 5,460,791 | Si | 86.0 | 169 | A |
| Sample 1-6 | 270 | 380 | 3,168,736 | 3,649,710 | Si | 89.0 | 162 | A |
| Sample 1-7 | 230 | None | 9,869,512 | None | Si | 88.0 | Unmeasurable | D |
| Sample 1-8 | 240 | None | 9,664,970 | None | Si | 88.0 | Unmeasurable | D |
| Sample 1-9 | 250 | None | 9,498,612 | None | Si | 90.0 | Unmeasurable | D |
| Sample 1-10 | 245 | None | 9,637,914 | None | Si | 90.0 | Unmeasurable | D |
| Sample 1-11 | 230 | None | 9,869,512 | None | Si | 87.5 | Unmeasurable | D |
| Sample 1-12 | 270 | None | 7,137,792 | None | Si | 91.0 | Unmeasurable | D |

As shown in Table 1, each positive electrode active material of the samples 1-1 to 1-6, on which the deoxidizing treatment according to an embodiment of the present disclosure was performed, has a smaller oxygen generation amount than each positive electrode active material of the samples 1-7 to 1-12, on which the deoxidizing treatment was not performed. Further, each battery of the samples 1-1 to 1-6 has the same or higher initial charge/discharge efficiency as each battery of the samples 1-7 to 1-12, and the highest temperature on the battery surface of e the samples 1-1 to 1-6 became low. Furthermore, each of the samples 1-1 to 1-4 and 1-6 has a lower highest temperature on the battery surface, of which the second peak appeared in a region of 250° C. or higher, than the sample 1-5 of which the second peak appeared at 240° C.

Note that as for the samples 1-7 to 1-12, batteries were exploded, for example, during high temperature storing, so that the battery temperatures after the high temperature storing were not able to be measured. This is considered to be because the gas (oxygen) generation amount during the high temperature storing was too large to be handled by the gas releasing function of the safety valve mechanism in the battery.

<Samples 2-1 to 2-7>

Samples 2-1 to 2-7 were fabricated by changing the mixed amount of carbon, which is a reducing agent, and by baking the lithium transition metal composite oxide, and characteristics evaluation thereof were evaluated.

<Samples 2-1 to 2-6>

Seven cylindrical batteries were fabricated in the same manner as the sample 1-1 except that the mixed amounts of carbon mixed with the lithium transition metal composite oxide were adjusted to be 0.08 parts, 0.1 parts, 1 part, 10 parts, 20 parts, and 21 parts, respectively, with respect to 95 parts of the lithium transition metal composite oxide. The peak intensity ratios I₀₀₃/I₁₀₄ by X-ray diffraction measurements, and the first peaks and the second peaks of the oxygen generation temperature in the heating process were as shown in Table 2.

<Sample 2-7>

A cylindrical battery was fabricated in the same manner as the sample 1-1 except that carbon was not mixed with the lithium transition metal composite oxide. The peak intensity ratio I₀₀₃/I₁₀₄ by an X-ray diffraction measurement, and the first peak and the second peak of the oxygen generation temperature in the heating process were as shown in Table 2.

[Evaluation of Batteries]

(a) Initial Charge/Discharge Efficiency

(b) Highest Temperature on Battery Surface

In the same manner as the sample 1-1, the initial charge/discharge efficiency and the highest temperatures on the battery surfaces were evaluated.

Evaluation results are shown in Table 2 below.

TABLE 2

Positive Electrode

| | Composite Oxide | | Mass Ratio | Baking | |
|---|---|---|---|---|---|
| | Before Deoxidizing | Reducing | Active Material/ | Temp. | XRD |
| | Treatment | Agent | Reducing Agent | [° C.] | Ratio |
| Sample 2-1 | LiNi_{0.8}Co_{0.15}Al_{0.05}O₂ | Carbon | 95/0.08 | 550 | 0.86 |
| Sample 2-2 | | | 95/0.1 | | 0.80 |
| Sample 2-3 | | | 95/1 | | 0.79 |
| Sample 1-1 | | | 95/5 | | 0.75 |
| Sample 2-4 | | | 95/10 | | 0.71 |
| Sample 2-5 | | | 95/20 | | 0.65 |
| Sample 2-6 | | | 95/21 | | 0.63 |
| Sample 1-7 | LiNi_{0.8}Co_{0.15}Al_{0.05}O₂ | — | 95/0 | — | 0.87 |
| Sample 2-7 | | | 95/0 | 550 | 0.87 |

| | Positive Electrode | | | | | | | |
|---|---|---|---|---|---|---|---|---|
| | Oxygen | | | | Negative | | | |
| | Generation | | Oxygen Generation | | Electrode | Initial | Highest Temp. | |
| | Temp. [° C.] | | Amount (a.u.) | | Active | Efficiency | On Battery | |
| | 1st Peak | 2nd Peak | 1st Peak | 2nd Peak | Material | [%] | Surface [° C.] | Evaluation |
| Sample 2-1 | 230 | 240 | 8,931,241 | 1,112,055 | Si | 88.0 | 296 | C |
| Sample 2-2 | 230 | 270 | 7,972,649 | 1,464,350 | | 87.7 | 179 | A |
| Sample 2-3 | 230 | 280 | 6,164,795 | 4,694,134 | | 87.3 | 172 | A |
| Sample 1-1 | 230 | 300 | 5,051,678 | 5,619,953 | | 87.0 | 167 | A |
| Sample 2-4 | 230 | 330 | 2,165,330 | 7,941,374 | | 84.5 | 162 | A |
| Sample 2-5 | 230 | 380 | 1,689,746 | 8,966,479 | | 83.9 | 158 | A |
| Sample 2-6 | 230 | 420 | 956,325 | 6,168,974 | | 67.3 | 155 | B |
| Sample 1-7 | 230 | None | 9,869,512 | None | Si | 88.0 | Unmeasurable | D |
| Sample 2-7 | 230 | None | 9,739,147 | None | | 88.0 | Unmeasurable | D |

Note that Table 2 also shows the sample 1-1 which was subjected to the baking at 550° C. and used the same lithium transition metal composite oxides each of the samples 2-1 to 2-6, and the sample 1-7 using the same lithium transition metal composite oxide without any treatment as the positive electrode active material.

As shown in Table 2, each of the samples 2-1 to 2-6 subjected to the deoxidizing treatment according to an embodiment of the present disclosure had a smaller oxygen generation amount than each of the samples 1-1 and 2-7 which was not subjected to the deoxidizing treatment. Further, in the samples 2-1 to 2-6 and 1-1, as the addition of carbon was increased, the highest temperature on the battery surface was decreased. In particular, in order to increase the initial charge/discharge efficiency and to suppress the highest temperature on the battery surface, it is preferable that the mixed amount of the reducing agent with respect to 95 parts of the lithium transition metal composite oxide in the deoxidizing treatment is greater than or equal to 0.1 parts and less than or equal to 20 parts.

On the other hand, as for the samples 1-7 and 2-7, on which the treatment of adding carbon according to an embodiment of the present disclosure was not performed, the battery was exploded, for example, during the high temperature storing, and the battery temperature after the high temperature storing was not able to be measured.

<Samples 3-1 to 3-9>

Samples 3-1 to 3-9 were fabricated by changing materials used as reducing agents and by performing the deoxidizing treatment, and battery characteristics thereof were evaluated.

<Sample 3-1>

A cylindrical battery was fabricated in the same manner as the sample 1-1 except that copper (Cu) powder was used as a reducing agent and the baking temperature at the time of the deoxidizing treatment was 800° C., at which the reduction had high effects in combination with copper. The peak intensity ratio I₀₀₃/I₁₀₄ by an X-ray diffraction measurement, and the first peak and the second peak of the oxygen generation temperature in the heating process were as shown in Table 3. As for the following samples, the peak intensity ratios I₀₀₃/I₁₀₄, and the first peaks and the second peaks of the oxygen generation temperature in the heating process were shown in the same manner.

<Sample 3-2>

A cylindrical battery was fabricated in the same manner as the sample 1-1 except that nickel (Ni) powder was used as a reducing agent and the baking temperature at the time of the deoxidizing treatment was 850° C., at which the reduction had high effects in combination with nickel.

<Sample 3-3>

A cylindrical battery was fabricated in the same manner as the sample 1-1 except that molybdenum (Mo) powder was used as a reducing agent and the baking temperature at the time of the deoxidizing treatment was 900° C., at which the reduction had high effects in combination with molybdenum.

<Sample 3-4>

A cylindrical battery was fabricated in the same manner as the sample 1-1 except that sodium ascorbate was used as a reducing agent and the baking temperature at the time of the deoxidizing treatment was 440° C., at which the reduction has high effects in combination with sodium ascorbate.

<Sample 3-5>

A cylindrical battery was fabricated in the same manner as the sample 1-1 except that tin chloride dihydrate was used as a reducing agent and the baking temperature at the time of the deoxidizing treatment was 680° C., at which the reduction had high effects in combination with tin chloride dihydrate.

<Sample 3-6>

A cylindrical battery was fabricated in the same manner as the sample 1-1 except that a lithium-nickel-cobalt-aluminum composite oxide (LiNi_{0.8}CO_{0.15}Al_{0.05}O₂) which was not subjected to the deoxidizing treatment was used as the positive electrode active material, and 5 mass % of SiO_{0.5} powder (oxygen-deficient non-stoichiometric oxide) was mixed with 95 mass % of the positive electrode active material.

<Sample 3-7>

A cylindrical battery was fabricated in the same manner as the sample 1-1 except that a lithium-nickel-cobalt-aluminum composite oxide (LiNi_{0.8}Co_{0.15}Al_{0.05}O₂) which was not subjected to the deoxidizing treatment was used as the positive electrode active material, and 10 mass % of lithium molybdenum oxide (LiMoO₂) having an oxygen-absorbing function was mixed with 90 mass % of the positive electrode active material in the positive electrode active material layer.

<Sample 3-8>

A cylindrical battery was fabricated in the same manner as the sample 1-1 except that a lithium-nickel-cobalt-aluminum composite oxide (LiNi_{0.8}CO_{0.15}Al_{0.05}O₂) which was not subjected to the deoxidizing treatment was used as the positive electrode active material, and 10 mass % of V₂O₅ having an oxygen-absorbing function was mixed with 90 mass % of the positive electrode active material in the positive electrode active material in the positive electrode active material layer.

<Sample 3-9>

A cylindrical battery was fabricated in the same manner as the sample 1-1 except that a lithium-nickel-cobalt-aluminum composite oxide (LiNi_{0.8}CO_{0.15}Al_{0.05}O₂) which was not subjected to the deoxidizing treatment and which had a surface covered with titanium (Ti) was used as the positive electrode active material.

[Evaluation of Battery]

(a) Initial Charge/Discharge Efficiency

(b) Highest Temperature on Battery Surface

In the same manner as the sample 1-1, the initial charge/discharge efficiency and the highest temperatures on the battery surfaces were evaluated.

Evaluation results are shown in Table 3 below.

TABLE 3
Composite Oxide Before Deoxidizing Treatment: LiNi0.8Co0.15Al0.05O2 (Sample 1-1, Samples 3-1 to 3-7)

Positive Electrode

| | | | |
|---|---|---|---|
| Mass Ratio | Baking | | Oxygen Generation |
| Active Material/ | Temp. | XRD | Temp. [° C.] |

| | Reducing Agent | Reducing Agent | [° C.] | Ratio | 1st Peak | 2nd Peak |
|---|---|---|---|---|---|---|
| Sample 1-1 | Carbon | 95/5 | 550 | 0.75 | 230 | 300 |
| Sample 3-1 | Cu | | 800 | 0.78 | 230 | 280 |
| Sample 3-2 | Ni | | 850 | 0.77 | 230 | 290 |
| Sample 3-3 | Mo | | 900 | 0.72 | 230 | 320 |
| Sample 3-4 | Sodium Ascorbate | | 440 | 0.76 | 230 | 260 |
| Sample 3-5 | Tin Chloride Dihydrate | | 680 | 0.76 | 230 | 280 |
| Sample 3-6 | — | — | — | 0.87 | 230 | None |
| Sample 3-7 | — | | — | 0.86 | 230 | None |
| Sample 3-8 | — | | — | 0.87 | 230 | None |
| Sample 3-9 | — | | — | 0.87 | 230 | None |

| | Positive Electrode | | | Negative | | | |
|---|---|---|---|---|---|---|---|
| | Oxygen Generation | | Oxygen Abdorbing | Electrode | Initial | Highest Temp. | |
| | Amount (a.u.) | | Material Mixed With | Active | Efficiency | On Battery | |
| | 1st Peak | 2nd Peak | Active Material | Material | [%] | Surface [° C.] | Evaluation |
| Sample 1-1 | 5,051,678 | 5,619,953 | — | Si | 87.0 | 167 | A |
| Sample 3-1 | 5,163,713 | 5,635,491 | — | | 87.0 | 173 | A |
| Sample 3-2 | 4,697,731 | 6,100,366 | — | | 87.0 | 167 | A |
| Sample 3-3 | 4,942,117 | 5,497,997 | — | | 87.0 | 161 | A |
| Sample 3-4 | 3,933,619 | 6,469,777 | — | | 87.0 | 167 | A |
| Sample 3-5 | 3,975,276 | 6,767,817 | — | | 87.0 | 161 | A |
| Sample 3-6 | 9,167,118 | None | SiO_{0.5} | Si | 88.0 | Unmeasurable | D |
| Sample 3-7 | 10,691,144 | None | LiMoO₂ | | 88.0 | Unmeasurable | D |
| Sample 3-8 | 8,991,367 | None | V₂O₂ | | 88.0 | Unmeasurable | D |
| Sample 3-9 | 9,360,094 | None | Ti | | 88.0 | Unmeasurable | D |
| | | | (Covered With | | | | |
| | | | Active Material) | | | | |

Note that Table 3 also shows the sample 1-1 in which carbon was used as a reducing agent for the deoxidizing treatment.

As shown in Table 3, as for the samples 3-1 to 3-5 subjected to the treatment according to an embodiment of the present disclosure, the same initial charge/discharge efficiency and suppressing effects on the highest temperature on the battery surface were obtained as in the case of the sample 1-1 in which carbon was used as the reducing agent used at the time of the deoxidizing treatment.

On the other hand, as for the samples 3-6 to 3-9 each containing the material having the oxygen-absorbing function in the negative electrode or the positive electrode together with the positive electrode active material which was not subjected to the treatment according to an embodiment of the present disclosure, the battery was exploded, for example, during the high temperature storing, and the battery temperature after the high temperature storing was not able to be measured. This is considered to be because the gas (oxygen) generation amount during the high temperature storing was too large to be handled by the gas releasing function of the safety valve mechanism in the battery.

<Samples 4-1 to 4-3>

Samples 4-1 to 4-3 were fabricated by changing the negative electrode active material, and battery characteristics thereof were evaluated.

<Samples 4-1 to 4-3>

Three cylindrical batteries were fabricated in the same manner as the sample 1-1 except that carbon (C) powder, silicon monoxide (SiO) powder, and a mixed material of silicon powder and carbon powder were used, respectively, instead of silicon (Si) powder. The peak intensity ratio I₀₀₃/I₁₀₄ by an X-ray diffraction measurement, and the first peak and the second peak of the oxygen generation temperature in the heating process were as shown in Table 4.

[Evaluation of Battery]

(a) Initial Charge/Discharge Efficiency

(b) Highest Temperature on Battery Surface

In the same manner as the sample 1-1, the initial charge/discharge efficiency and the highest temperatures on the battery surfaces were evaluated.

Evaluation results are shown in Table 4 below.

TABLE 4

Positive Electrode

| | Composite Oxide | | Mass Ratio | Baking | |
|---|---|---|---|---|---|
| | Before Deoxidizing | Reducing | Active Material/ | Temp. | XRD |
| | Treatment | Agent | Reducing Agent | [° C.] | Ratio |
| Sample 1-1 | LiNi_{0.8}Co_{0.15}Al_{0.05}O₂ | Carbon | 95/5 | 550 | 0.75 |
| Sample 4-1 | | | | | |
| Sample 4-2 | | | | | |
| Sample 4-3 | | | | | |

| | Positive Electrode | | | | | | | |
|---|---|---|---|---|---|---|---|---|
| | Oxygen | | | | Negative | | | |
| | Generation | | Oxygen Generation | | Electrode | Initial | Highest Temp. | |
| | Temp. [° C.] | | Amount (a.u.) | | Active | Efficiency | On Battery | |
| | 1st Peak | 2nd Peak | 1st Peak | 2nd Peak | Material | [%] | Surface [° C.] | Evaluation |
| Sample 1-1 | 230 | 300 | 5,051,678 | 5,619,953 | Si | 87.0 | 167 | A |
| Sample 4-1 | | | | | C | 87.0 | 162 | A |
| Sample 4-2 | | | | | SiO | 87.0 | 163 | A |
| Sample 4-3 | | | | | Si + C | 87.0 | 165 | A |

Note that Table 4 also shows the sample 1-1 in which silicon (Si) powder was used as a negative electrode active material.

As shown in Table 4, as for the samples 4-1 to 4-3 each using the positive electrode active material subjected to the treatment according to an embodiment of the present disclosure, the same initial charge/discharge efficiency and suppressing effects on the highest temperature on the battery surface were obtained when any of the metal material, the metal-alloy material, the carbon material, and the mixed material thereof was used as a material for the negative electrode active material.

<Samples 5-1 to 5-5>

Samples 5-1 to 5-5 were fabricated by changing the baking temperature at the time of the deoxidizing treatment, and battery characteristics thereof were evaluated.

<Samples 5-1 to 5-4>

Four cylindrical batteries were fabricated in the same manner as the sample 1-1 except that the baking temperatures at the time of the deoxidizing treatment were set to 400° C., 500° C., 600° C., and 650° C., respectively, which were higher than or equal to the temperature at which carbon starts reducing.

Note that a graph denoted by reference numeral 402 in FIG. 11 shows the oxygen generation amount in the sample 5-4. Further, a graph denoted by reference numeral 412 in FIG. 12 shows heat generation amount of the positive electrode in the sample 5-4 with respect to the temperature measured by differential scanning calorimetry.

<Sample 5-5>

A cylindrical battery was fabricated in the same manner as the sample 1-1 except that the baking temperature at the time of the deoxidizing treatment was 395° C., which is lower than or equal to the temperature at which carbon starts reducing.

[Evaluation of Battery]

(a) Initial Charge/Discharge Efficiency

(b) Highest Temperature on Battery Surface

In the same manner as the sample 1-1, the initial charge/discharge efficiency and the highest temperatures on the battery surfaces were evaluated.

Evaluation results are shown in Table 5 below.

TABLE 5

Positive Electrode

| | Composite Oxide | | Mass Ratio | Baking | |
|---|---|---|---|---|---|
| | Before Deoxidizing | Reducing | Active Material/ | Temp. | XRD |
| | Treatment | Agent | Reducing Agent | [° C.] | Ratio |
| Sample 5-1 | LiNi_{0.8}Co_{0.15}Al_{0.05}O₂ | Carbon | 95/5 | 400 | 0.80 |
| Sample 5-2 | | | | 500 | 0.77 |
| Sample 1-1 | | | | 550 | 0.75 |
| Sample 5-3 | | | | 600 | 0.66 |
| Sample 5-4 | | | | 605 | 0.59 |
| Sample 5-5 | | | | 395 | 0.83 |
| Sample 1-7 | LiNi_{0.8}Co_{0.15}Al_{0.05}O₂ | — | 95/0 | — | 0.87 |

| | BPositive Electrode | | | | | | | |
|---|---|---|---|---|---|---|---|---|
| | Oxygen | | | | Negative | | | |
| | Generation | | Oxygen Generation | | Electrode | Initial | Highest Temp. | |
| | Temp. [° C.] | | Amount (a.u.) | | Active | Efficiency | On Battery | |
| | 1st Peak | 2nd Peak | 1st Peak | 2nd Peak | Material | [%] | Surface [° C.] | Evaluation |
| Sample 5-1 | 230 | 350 | 8,462,312 | 1,169,734 | Si | 87.0 | 177 | A |
| Sample 5-2 | 230 | 350 | 6,346,625 | 3,097,731 | | 87.5 | 173 | A |
| Sample 1-1 | 230 | 300 | 5,051,678 | 5,619,953 | | 87.0 | 167 | A |
| Sample 5-3 | 230 | 350 | 998,043 | 9,037,457 | | 84.5 | 161 | A |
| Sample 5-4 | 230 | 350 | 816,087 | 6,389,145 | | 65.0 | 157 | B |
| Sample 5-5 | 230 | 245 | 9,034,155 | 851,235 | | 88.0 | 322 | C |
| Sample 1-7 | 230 | None | 9,869,512 | None | Si | 88.0 | Unmeasurable | D |

Note that Table 5 also shows the sample 1-1 subjected to the baking at 550° C.

As shown in Table 5, each of the samples 5-1 to 5-5 and 1-1 using the positive electrode active material subjected to the treatment according to an embodiment of the present disclosure had a smaller oxygen generation amount than in a case where the treatment was not performed. Further, as the baking temperature was increased, the highest temperature on the battery surface was decreased. In particular, in order to increase the initial charge/discharge efficiency and to suppress the highest temperature on the battery surface, it is preferable that the baking temperature at the deoxidizing treatment when using carbon as a reducing agent is higher than or equal to 400° C. and lower than or equal to 600° C. In a case of using other materials as reducing agents, reduction starting temperatures differ depending on the materials, and accordingly, the baking temperature is not limited to the above temperature range.

FIG. 11 shows a graph of the results of the oxygen generation amounts in the samples 1-1, 5-4, and 1-7. As shown in the graph shown in FIG. 11, the first peak of the oxygen generation temperature in the heating process of the sample 1-7 (reference numeral 403), on which the deoxidizing treatment was not performed, was notably high, and the second peak was virtually gradual and did not appear clearly. By contrast, the sample 1-1 (reference numeral 401) and the sample 5-4 (reference numeral 402), which were subjected to the baking at 550° C. and 600° C., respectively, at the time of the deoxidizing treatment, had the low first peak, and the second peak higher than the first peak appeared after the temperature was further increased. That is, it is found out that, since the temperature of the battery at which oxygen is generated shifts to a higher temperature side and the oxygen generation amount itself is small, oxygen is unlikely to be generated even in an abnormal state, e.g., when heat is generated. Further, it is considered that, since oxygen is unlikely to be generated, a process of heat generation in the inside of the battery can be suppressed.

FIG. 12 shows a graph of results of differential scanning calorimetry on the samples 1-1, 5-4, and 1-7. As shown in the graph in FIG. 12, it was confirmed that the sample 1-1 (reference numeral 411) and the sample 5-4 (reference numeral 412) subjected to the baking at 550° C. and 600° C., respectively, at the time of the deoxidizing treatment, had a small amount of heat generation than the sample 1-1 (reference numeral 413) which was not subjected to the deoxidizing treatment.

<Sample 6-1>

Into a lithium-manganese composite oxide (LiMn₂O₄), which is a lithium transition metal composite oxide, carbon (Ketjen black), which is also used as a conductive material, was mixed as a reducing agent. This mixture was baked at 600° C. under a nitrogen atmosphere for 240 minutes. Thus, a positive electrode active material in which oxygen was extracted from the lithium transition metal composite oxide (LiMn₂O₄) was obtained. The mixed amount of carbon was 5 parts with respect to 95 parts of the lithium transition metal composite oxide (lithium transition metal composite oxide:reducing agent=95:5 in mass ratio). Note that the temperature at which carbon starts reducing is 400° C. In this manner, the positive electrode active material of the target sample 6-1 was obtained.

<Sample 6-2>

A positive electrode active material was obtained in the same manner as the sample 6-1 except that the deoxidizing treatment (mixing of carbon and baking) was not performed on the lithium transition metal composite oxide.

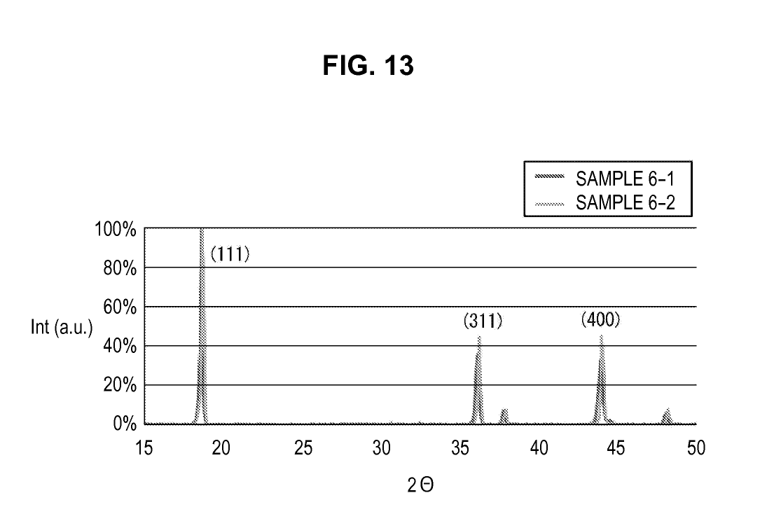

Further, the positive electrode active material (sample 6-1) subjected to the deoxidizing treatment and the positive electrode active material (sample 6-2) which was not subjected to the deoxidizing treatment were subjected to X-ray diffraction (XRD) measurements. In the X-ray diffraction measurements, peak intensity I₃₁₁ of a peak attributed to a (311) plane and peak intensity I₁₁₁ of a peak attributed to a (111) plane were measured, and the ratio thereof I₃₁₁/I₁₁₁ was calculated. A graph of measurement results obtained by the X-ray diffraction measurements on the samples 6-1 and 6-2 is shown in FIG. 13. The peak intensity ratio I₃₁₁/I₁₁₁ of the sample 6-1 was 0.36, and the peak internist ratio I₃₁₁/I₁₁₁ of the sample 6-2 was 0.44.

Additionally, the present application may also be configured as below.

(1) A battery including:

a positive electrode;

a negative electrode; and

an electrolyte,

wherein the positive electrode includes a positive electrode active material layer on at least one surface of a positive electrode current collector, the positive electrode active material layer including a binder and a positive electrode active material of a deoxidized lithium transition metal composite oxide,

wherein the positive electrode active material layer shows a first peak and a second peak of oxygen amounts generated from a type of the positive electrode active material in the positive electrode active material layer when the positive electrode active material layer is heated in a charge state of higher than or equal to 4.2 V and lower than or equal to 4.5 V in a lithium antipode potential, the second peak appearing in a temperature region higher than a temperature region of the first peak, and

wherein at least the second peak appears in a temperature region higher than 220° C.

(2) The battery according to (1), wherein the deoxidized lithium transition metal composite oxide is obtained through a reduction.
(3) The battery according to (1) or (2), wherein the positive electrode active material layer further includes at least one of a reducing agent and an oxide of the reducing agent.
(4) The battery according to (3), wherein the positive electrode active material layer includes the at least one of the reducing agent and the oxide of the reducing agent in combination with or separately from the deoxidized lithium transition metal composite oxide.
(5) The battery according to (3) or (4), wherein the positive electrode active material layer includes the at least one of the reducing agent and the oxide of the reducing agent as at least a part of a conductive material.
(6) The battery according to any one of (3) to (5), wherein the reducing agent is one selected from the group consisting of a carbon material, a metal material, an organic material, and an inorganic material.

(7) The battery according to any one of (1) to (6), wherein the deoxidized lithium transition metal composite oxide is obtained from at least one of a deoxidized lithium transition metal composite oxide having a layered rock salt structure in which a peak intensity ratio I₀₀₃/I₁₀₄, which is a ratio of diffracted peak intensity I₀₀₃ of a peak attributed to a (003) plane to diffracted peak intensity I₁₀₄ of a peak attributed to a (104) plane, is higher than or equal to 0.65 and lower than or equal to 0.80, and a deoxidized lithium transition metal composite oxide having a spinel structure in which a peak intensity ratio I₃₁₁/I₁₁₁, which is a ratio of diffracted peak intensity I₃₁₁ of a peak attributed to a (311) plane to diffracted peak intensity I₁₁₁ of a peak attributed to a (111) plane, is higher than or equal to 0.30 and lower than or equal to 0.40, the diffracted peak intensity being measured in an X-ray diffraction measurement using a CuKα-ray for an X-ray source.

(8) The battery according to (7), wherein a transition metal in the deoxidized lithium transition metal composite oxide having the layered rock salt structure contains at least nickel (Ni) and a ratio of nickel (Ni) in the transition metal is higher than or equal to 50 mol %.
(9) A battery including:

a positive electrode;

a negative electrode; and

an electrolyte,

wherein the positive electrode includes a positive electrode active material layer on at least one surface of a positive electrode current collector, the positive electrode active material layer including a binder and a positive electrode active material of a deoxidized lithium transition metal composite oxide, and

wherein the deoxidized lithium transition metal composite oxide is at least one of a deoxidized lithium transition metal composite oxide having a layered rock salt structure in which a peak intensity ratio I₀₀₃/I₁₀₄, which is a ratio of diffracted peak intensity I₀₀₃ of a peak attributed to a (003) plane to diffracted peak intensity I₁₀₄ of a peak attributed to a (104) plane, is higher than or equal to 0.65 and lower than or equal to 0.80, and a deoxidized lithium transition metal composite oxide having a spinel structure in which a peak intensity ratio I₃₁₁/I₁₁₁, which is a ratio of diffracted peak intensity I₃₁₁ of a peak attributed to a (311) plane to diffracted peak intensity I₁₁₁ of a peak attributed to a (111) plane, is higher than or equal to 0.30 and lower than or equal to 0.40, the diffracted peak intensity being measured in an X-ray diffraction measurement using a CuKα-ray for an X-ray source.

(10) A positive electrode active material including:

at least one of a deoxidized lithium transition metal composite oxide having a layered rock salt structure in which a peak intensity ratio I₀₀₃/I₁₀₄, which is a ratio of diffracted peak intensity I₀₀₃ of a peak attributed to a (003) plane to diffracted peak intensity I₁₀₄ of a peak attributed to a (104) plane, is higher than or equal to 0.65 and lower than or equal to 0.80, and a deoxidized lithium transition metal composite oxide having a spinel structure in which a peak intensity ratio I₃₁₁/I₁₁₁, which is a ratio of diffracted peak intensity I₃₁₁ of a peak attributed to a (311) plane to diffracted peak intensity I₁₁₁ of a peak attributed to a (111) plane, is higher than or equal to 0.30 and lower than or equal to 0.40, the diffracted peak intensity being measured in an X-ray diffraction measurement using a CuKα-ray for an X-ray source.

(11) A positive electrode including:

a positive electrode active material layer on at least one surface of a positive electrode current collector, the positive electrode active material layer including a binder and a positive electrode active material of a deoxidized lithium transition metal composite oxide,

wherein the deoxidized lithium transition metal composite oxide is at least one of a deoxidized lithium transition metal composite oxide having a layered rock salt structure in which a peak intensity ratio I₀₀₃/I₁₀₄, which is a ratio of diffracted peak intensity I₀₀₃ of a peak attributed to a (003) plane to diffracted peak intensity I₁₀₄ of a peak attributed to a (104) plane, is higher than or equal to 0.65 and lower than or equal to 0.80, and a deoxidized lithium transition metal composite oxide having a spinel structure in which a peak intensity ratio I₃₁₁/I₁₁₁, which is a ratio of diffracted peak intensity I₃₁₁ of a peak attributed to a (311) plane to diffracted peak intensity I₁₁₁ of a peak attributed to a (111) plane, is higher than or equal to 0.30 and lower than or equal to 0.40, the diffracted peak intensity being measured in an X-ray diffraction measurement using a CuKα-ray for an X-ray source.

(12) A method for manufacturing a positive electrode active material, the method including:

mixing a lithium transition metal composite oxide and a reducing agent; and

baking the reducing agent and the lithium transition metal composite oxide under a non-oxygen atmosphere at a temperature higher than or equal to a temperature at which the reducing agent starts reducing.

(13) The method for manufacturing the positive electrode active material, according to (12),

wherein the reducing agent is a carbon material, and

wherein a baking temperature at the baking is higher than or equal to 400° C. and lower than or equal to 600° C.

(14) The method for manufacturing the positive electrode active material, according to (12) or (13),

wherein the reducing agent is a carbon material, and

wherein a mixed amount of the reducing agent is greater than or equal to 0.1 parts and less than or equal to 20 parts with respect to 95 parts of the lithium transition metal composite oxide.

(15) A battery pack including:

the battery according to (1) or (9);

a controller configured to control the battery; and

a package including the battery.

(16) An electronic device including:

the battery according to (1) or (9),

wherein power is supplied from the battery.

(17) An electric vehicle including:

the battery according to (1) or (9);

a converting device configured to convert power supplied from the battery into driving power of a vehicle; and

a control device configured to perform information processing about vehicle control based on information about the battery.

(18) A power storage device including:

the battery according to (1) or (9),

wherein the power storage device supplies power to an electronic device connected to the battery.

(19) The power storage device according to (18), including:

a power information control device configured to transmit and receive a signal to and from another device via a network,

wherein charge/discharge of the battery is controlled based on information received by the power information control device.

(20) A power system configured to enable power supply from the battery according to (1) or (9), or to enable power supply to the battery according to (1) or (9) from a power generation device or a power network.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery comprising:
a positive electrode;
a negative electrode; and
an electrolyte,
wherein the positive electrode includes a positive electrode active material layer on at least one surface of a positive electrode current collector, the positive electrode active material layer including a binder and a positive electrode active material of a deoxidized lithium transition metal composite oxide,
wherein the positive electrode active material layer shows a first peak and a second peak of oxygen amounts generated from a type of the positive electrode active material in the positive electrode active material layer when the positive electrode active material layer is heated in a charge state of higher than or equal to 4.2 V and lower than or equal to 4.5 V in a lithium antipode potential, the second peak appearing in a temperature region higher than a temperature region of the first peak, and
wherein at least the second peak appears in a temperature region higher than 220° C.

2. The battery according to claim 1, wherein the deoxidized lithium transition metal composite oxide is obtained through a reduction.

3. The battery according to claim 1, wherein the positive electrode active material layer further includes at least one of a reducing agent and an oxide of the reducing agent.

4. The battery according to claim 3, wherein the positive electrode active material layer includes the at least one of the reducing agent and the oxide of the reducing agent in combination with or separately from the deoxidized lithium transition metal composite oxide.

5. The battery according to claim 3, wherein the positive electrode active material layer includes the at least one of the reducing agent and the oxide of the reducing agent as at least a part of a conductive material.

6. The battery according to claim 3, wherein the reducing agent is one selected from the group consisting of a carbon material, a metal material, an organic material, and an inorganic material.

7. The battery according to claim 1, wherein the deoxidized lithium transition metal composite oxide is obtained from at least one of a deoxidized lithium transition metal composite oxide having a layered rock salt structure in which a peak intensity ratio I₀₀₃/I₁₀₄, which is a ratio of diffracted peak intensity I₀₀₃ of a peak attributed to a (003) plane to diffracted peak intensity I₁₀₄ of a peak attributed to a (104) plane, is higher than or equal to 0.65 and lower than or equal to 0.80, and a deoxidized lithium transition metal composite oxide having a spinel structure in which a peak intensity ratio I₃₁₁/I₁₁₁, which is a ratio of diffracted peak intensity I₃₁₁ of a peak attributed to a (311) plane to diffracted peak intensity I₁₁₁ of a peak attributed to a (111) plane, is higher than or equal to 0.30 and lower than or equal to 0.40, the diffracted peak intensity being measured in an X-ray diffraction measurement using a CuKα-ray for an X-ray source.

8. The battery according to claim 7, wherein a transition metal in the deoxidized lithium transition metal composite oxide having the layered rock salt structure contains at least nickel (Ni) and a ratio of nickel (Ni) in the transition metal is higher than or equal to 50 mol %.

9. A battery comprising:
a positive electrode;
a negative electrode; and
an electrolyte,
wherein the positive electrode includes a positive electrode active material layer on at least one surface of a positive electrode current collector, the positive electrode active material layer including a binder and a positive electrode active material of a deoxidized lithium transition metal composite oxide, and
wherein the deoxidized lithium transition metal composite oxide is at least one of a deoxidized lithium transition metal composite oxide having a layered rock salt structure in which a peak intensity ratio I₀₀₃/I₁₀₄, which is a ratio of diffracted peak intensity I₀₀₃ of a peak attributed to a (003) plane to diffracted peak intensity I₁₀₄ of a peak attributed to a (104) plane, is higher than or equal to 0.65 and lower than or equal to 0.80, and a deoxidized lithium transition metal composite oxide having a spinel structure in which a peak intensity ratio I₃₁₁/I₁₁₁, which is a ratio of diffracted peak intensity I₃₁₁ of a peak attributed to a (311) plane to diffracted peak intensity I₁₁₁ of a peak attributed to a (111) plane, is higher than or equal to 0.30 and lower than or equal to 0.40, the diffracted peak intensity being measured in an X-ray diffraction measurement using a CuKα-ray for an X-ray source.

10. A positive electrode active material comprising:
at least one of a deoxidized lithium transition metal composite oxide having a layered rock salt structure in which a peak intensity ratio I₀₀₃/I₁₀₄, which is a ratio of diffracted peak intensity I₀₀₃ of a peak attributed to a (003) plane to diffracted peak intensity I₁₀₄ of a peak attributed to a (104) plane, is higher than or equal to 0.65 and lower than or equal to 0.80, and a deoxidized lithium transition metal composite oxide having a spinel structure in which a peak intensity ratio I₃₁₁/I₁₁₁, which is a ratio of diffracted peak intensity I₃₁₁ of a peak attributed to a (311) plane to diffracted peak intensity I₁₁₁ of a peak attributed to a (111) plane, is higher than or equal to 0.30 and lower than or equal to 0.40, the diffracted peak intensity being measured in an X-ray diffraction measurement using a CuKα-ray for an X-ray source.

11. A positive electrode comprising:
a positive electrode active material layer on at least one surface of a positive electrode current collector, the positive electrode active material layer including a binder and a positive electrode active material of a deoxidized lithium transition metal composite oxide,
wherein the deoxidized lithium transition metal composite oxide is at least one of a deoxidized lithium transition metal composite oxide having a layered rock salt structure in which a peak intensity ratio I₀₀₃/I₁₀₄, which is a ratio of diffracted peak intensity I₁₀₃ of a peak attributed to a (003) plane to diffracted peak intensity I₁₀₄ of a peak attributed to a (104) plane, is higher than or equal to 0.65 and lower than or equal to 0.80, and a deoxidized lithium transition metal composite oxide having a spinel structure in which a peak intensity ratio I₃₁₁/I₁₁₁, which is a ratio of diffracted peak intensity I₃₁₁ of a peak attributed to a (311) plane to diffracted peak intensity I₁₁₁ of a peak attributed to a (111) plane, is higher than or equal to 0.30 and lower than or equal to 0.40, the diffracted peak intensity being measured in an X-ray diffraction measurement using a CuKα-ray for an X-ray source.

12. A method for manufacturing a positive electrode active material, the method comprising:
mixing a lithium transition metal composite oxide and a reducing agent; and
baking the reducing agent and the lithium transition metal composite oxide under a non-oxygen atmosphere at a temperature higher than or equal to a temperature at which the reducing agent starts reducing.

13. The method for manufacturing the positive electrode active material, according to claim 12,
wherein the reducing agent is a carbon material, and
wherein a baking temperature at the baking is higher than or equal to 400° C. and lower than or equal to 600° C.

14. The method for manufacturing the positive electrode active material, according to claim 12,
wherein the reducing agent is a carbon material, and
wherein a mixed amount of the reducing agent is greater than or equal to 0.1 parts and less than or equal to 20 parts with respect to 95 parts of the lithium transition metal composite oxide.

15. A battery pack comprising:
the battery according to claim 1;
a controller configured to control the battery; and
a package including the battery.

16. An electronic device comprising:
the battery according to claim 1,
wherein power is supplied from the battery.

17. An electric vehicle comprising:
the battery according to claim 1;
a converting device configured to convert power supplied from the battery into driving power of a vehicle; and
a control device configured to perform information processing about vehicle control based on information about the battery.

18. A power storage device comprising:
the battery according to claim 1,
wherein the power storage device supplies power to an electronic device connected to the battery.

19. The power storage device according to claim 18, comprising:
a power information control device configured to transmit and receive a signal to and from another device via a network,
wherein charge/discharge of the battery is controlled based on information received by the power information control device.

20. A power system configured to enable power supply from the battery according to claim 1, or to enable power supply to the battery according to claim 1 from a power generation device or a power network.
